(19) United States
(12) Patent Application Publication
(10) Pub. No.: US 2013/0107973 A1
(43) Pub. Date: May 2, 2013

(54) LOOP FILTERING CONTROL OVER TILE BOUNDARIES

(71) Applicant: Qualcomm Incorporated, San Diego, CA (US)

(72) Inventors: Ye-Kui Wang, San Diego, CA (US); In Suk Chong, San Diego, CA (US); Muhammed Zeyd Coban, San Diego, CA (US); Marta Karczewicz, San Diego, CA (US)

(73) Assignee: QUALCOMM INCORPORATED, San Diego, CA (US)

(21) Appl. No.: 13/660,789

(22) Filed: Oct. 25, 2012

Related U.S. Application Data
(60) Provisional application No. 61/553,074, filed on Oct. 28, 2011.

(51) Int. Cl. H04N 7/26

(52) U.S. Cl. 375/240.29; 375/E07.193

(57) ABSTRACT

A video coder can be configured to code a syntax element that indicates if a loop filtering operation, such as deblocking filtering, adaptive loop filtering, or sample adaptive offset filtering, is allowed across a tile boundary. A first value for the syntax element may indicate loop filtering is allowed across the tile boundary, and a second value for the syntax element may indicate loop filtering is not allowed across the tile boundary. If loop filtering is allowed across a tile boundary, additional syntax elements may indicate specifically for which boundaries loop filtering is allowed or disallowed.

This application claims the benefit of U.S. Provisional Application 61/553,074 filed Oct. 28, 2011, the entire of content of which is hereby incorporated by reference.

### TECHNICAL FIELD

This disclosure relates to block-based digital video coding used to compress video data and, more particularly, to techniques for controlling loop filtering operations across tile boundaries.

### BACKGROUND

Digital video capabilities can be incorporated into a wide range of devices, including digital televisions, digital direct broadcast systems, wireless communication devices such as radio telephone handsets, wireless broadcast systems, personal digital assistants (PDAs), laptop computers, desktop computers, tablet computers, digital cameras, digital recording devices, video gaming devices, video game consoles, and the like. Digital video devices implement video compression techniques, such as MPEG-2, MPEG-4, or ITU-T H.264/MPEG-4, Part 10, Advanced Video Coding (AVC), to transmit and receive digital video more efficiently. Video compression techniques perform spatial and temporal prediction to reduce or remove redundancy inherent in video sequences. New video standards, such as the High Efficiency Video Coding (HEVC) standard being developed by the “Joint Collaborative Team—Video Coding” (JCTVC), which is a collaboration between MPEG and ITU-T, continue to emerge and evolve. This new HEVC standard is also sometimes referred to as H.265.

Block-based video compression techniques may perform spatial prediction and/or temporal prediction. Intra-coding relies on spatial prediction to reduce or remove spatial redundancy between video blocks within a given unit of coded video, which may comprise a video frame, a slice of a video frame, or the like. In contrast, inter-coding relies on temporal prediction to reduce or remove temporal redundancy between video blocks of successive coding units of a video sequence. For intra-coding, a video encoder performs spatial prediction to compress data based on other data within the same unit of coded video. For inter-coding, the video encoder performs motion estimation and motion compensation to track the movement of corresponding video blocks of two or more adjacent units of coded video.

A coded video block may be represented by prediction information that can be used to create or identify a predictive block, and a residual block of data indicative of differences between the block being coded and the predictive block. In the case of inter-coding, one or more motion vectors are used to identify the predictive block of data from a previous or subsequent coding unit, while in the case of intra-coding, the prediction mode can be used to generate the predictive block based on data within the CU associated with the video block being coded. Both intra-coding and inter-coding may define several different prediction modes, which may define different block sizes and/or prediction techniques used in the coding. Additional types of syntax elements may also be included as part of encoded video data in order to control or define the coding techniques or parameters used in the coding process.

After block-based prediction coding, the video encoder may apply transform, quantization and entropy coding processes to further reduce the bit rate associated with communication of a residual block. Transform techniques may comprise discrete cosine transforms (DCTs) or conceptually similar processes, such as wavelet transforms, integer transforms, or other types of transforms. In a discrete cosine transform process, as an example, the transform process converts a set of pixel difference values into transform coefficients, which may represent the energy of the pixel values in the frequency domain. Quantization is applied to the transform coefficients, and generally involves a process that limits the number of bits associated with any given transform coefficient. Entropy coding comprises one or more processes that collectively compress a sequence of quantized transform coefficients.

Filtering of video blocks may be applied as part of the encoding and decoding processes, or as part of a post-filtering process on reconstructed video blocks. Filtering is commonly used, for example, to reduce blockiness or other artifacts common to block-based video coding. Filter coefficients (sometimes called filter taps) may be defined or selected in order to promote desirable levels of filtering that can reduce blockiness and/or improve the video quality in other ways. A set of filter coefficients, for example, may define how filtering is applied along edges of video blocks or other locations within video blocks. Different filter coefficients may cause different levels of filtering with respect to different pixels of the video blocks. Filtering, for example, may smooth or sharpen differences in intensity of adjacent pixel values in order to help eliminate unwanted artifacts.

### SUMMARY

In general, this disclosure describes techniques for coding video data, and more particularly, this disclosure describes techniques related to loop filtering operations for video coding, including controlling loop filtering operations at the boundaries of tiles within pictures of video data.

In one example, a method of coding video data includes coding, for a picture of video data that is partitioned into tiles, a first value for a first syntax element, wherein the first value for the first syntax element indicates that loop filtering operations are allowed across at least one tile boundary within the picture; and, performing the one or more loop filtering operations across the at least one tile boundary in response to the first value indicating that the loop filtering operations are allowed across the tile boundary.

In another example, a device for coding video data includes a video coder configured to code, for a picture of video data that is partitioned into tiles, a first value for a first syntax element, wherein the first value for the first syntax element indicates that loop filtering operations are allowed across at least one tile boundary within the picture, and; perform the one or more loop filtering operations across the at least one tile boundary in response to the first value indicating that the loop filtering operations are allowed across the tile boundary.

In another example, a device for coding video data includes means for coding, for a picture of video data that is partitioned into tiles, a first value for a first syntax element, wherein the first value for the first syntax element indicates that loop filtering operations are allowed across at least one tile boundary within the picture; and, means for performing the one or more loop filtering operations across the at least one tile boundary in response to the first value indicating that the loop filtering operations are allowed across the tile boundary.

In another example, a non-transitory computer-readable storage medium stores instructions that when executed by one or more processors cause the one or more processors to code, for a picture of video data that is partitioned into tiles, a first value for a first syntax element, wherein the first value for the first syntax element indicates that loop filtering operations are allowed across at least one tile boundary within the picture; and, to perform the one or more loop filtering operations across the at least one tile boundary in response to the first value indicating that the loop filtering operations are allowed across the tile boundary.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system

FIG. 2 is a conceptual diagram showing region-based classification for an adaptive loop filter.

FIG. 3 is a conceptual diagram showing block-based classification for an adaptive loop filter.

FIG. 4 is a conceptual diagram showing tiles of a frame.

FIG. 5 is a conceptual diagram showing slices of a frame.

FIG. 6 is conceptual diagram depicting an adaptive loop filter at slice and tile boundaries.

FIG. 7 is conceptual diagram depicting asymmetric partial filters at a horizontal boundary.

FIG. 8 is conceptual diagram depicting asymmetric partial filters at a vertical boundary.

FIG. 9 is conceptual diagram depicting symmetric partial filters at a horizontal boundary.

FIG. 10 is conceptual diagram depicting symmetric partial filters at a vertical boundary.

FIG. 11 is a block diagram illustrating an example video encoder.

FIG. 12 is a block diagram illustrating an example video decoder.

FIG. 13 is a flowchart depicting an example method of controlling in-loop filtering across tile boundaries according to the techniques described in this disclosure.

FIG. 14 is a flowchart depicting an example method of controlling in-loop filtering across tile boundaries according to the techniques described in this disclosure.

FIG. 15 is a flowchart depicting an example method of controlling in-loop filtering across tile boundaries according to the techniques described in this disclosure.

### DETAILED DESCRIPTION

In general, this disclosure describes techniques for coding video data, and more particularly, this disclosure describes techniques related to loop filtering operations for video coding, including controlling loop filtering operations at the boundaries of tiles within pictures of video data. Controlling loop filtering operations at tile boundaries may, for example, allow for loop filtering across tile boundaries to be enabled when it will improve coding quality, but also allow for loop filtering across tile boundaries to be disabled when desirable, such as in instances when it may be desirable enable parallel decoding of slices. Examples of loop filtering operations that can be controlled using the techniques described in this disclosure include deblocking filtering operations, adaptive loop filtering (ALF) operations, and sample adaptive offset (SAO) filtering operations. These and other aspects of loop filtering will be described in greater detail below.

Conventionally, video coders have partitioned pictures of video data into slices that run in raster-scan order (e.g. left to right and top to bottom) across the picture. Some video coders now partition pictures of video data into tiles, using horizontal and vertical boundaries. When partitioned into tiles, a slice can run in raster scan order between edges of a tile. For example, there may be two horizontal and one vertical tile boundaries (not including the outer edges of the picture itself), dividing the picture into six tiles. A slice may exist entirely within a tile, and each tile may include multiple slices.

In many instances, various data for a block may be predicted based on neighboring, previously coded blocks. For example, in intra-prediction coding modes, pixel values are predicted for a current block using neighboring, previously coded blocks. Likewise, motion information prediction, coding mode prediction, and entropy coding contexts may utilize information from neighboring, previously coded blocks. In some cases, these neighboring, previously coded blocks may be located across a tile boundary, e.g., a horizontal or vertical tile boundary. A tile including a block that utilizes data from another block across a tile boundary is said to be “dependent” because coding the block of the tile depends on information related to a different block in a different tile.

In some cases, it may be advantageous to restrict cross-tile-boundary prediction, thereby rendering a tile independent, as opposed to dependent. Accordingly, in the newly emerging High Efficiency Video Coding (HEVC) standard, a value is signaled representative of whether cross-tile-boundary prediction is allowed. In particular, this value is referred to as the syntax element “tile_boundary_independence_idc.” However, in some versions of the HEVC standard, this value only relates to the use of certain information, such as the intra-prediction information, motion information, coding mode information, and the like, and does not relate to information related to loop filtering. In some implementations of HEVC, loop filtering is applied to block edges at tile boundaries regardless of the value of “tile_boundary_independence_idc.” This may lead to an otherwise independently coded tile being dependent upon, or providing information to, another tile when loop filtering operations are performed. This may, in some instances, lead to certain disadvantages, such as preventing parallel processing of tiles.

In some tile schemes proposed for inclusion in HEVC, in-picture prediction, including pixel value prediction, motion prediction, coding mode prediction, and entropy coding context prediction, can be controlled across all tile boundaries by the flag “tile_boundary_independence_idc,” while loop filtering across tile boundaries is not controlled. In some scenarios, however, it may be desirable to code one or more regions covered by different tiles completely independently, meaning that loop filtering is also not performed across tile boundaries. Two such scenarios are described below.

In the first scenario, a sequence of pictures is evenly partitioned into 8 tiles by 9 vertical tile boundaries, with the left-most tile being tile 0, and the second left-most tile being tile 1, and so on. Each of these pictures contain at least one predicted (P) slice, meaning there are pictures before the sequence of pictures in decoding order in the entire coded bitstream. For purposes of this example, the decoding order is assumed to be the same as the output order. In picture 0 (i.e., the first picture) in the sequence of pictures, all LCUs in tile 0 are intra coded, and all LCUs in other tiles are inter coded. In picture 1 in the sequence of pictures, all LCUs in tile 1 are intra coded, and all LCUs in other tiles are inter coded, and so on. In other words, in picture N in the sequence of pictures, all LCUs in tile N/8 (herein “/” denotes modular division) are intra coded, and all LCUs in other tiles are inter coded, for any value of N in the range of 0 to the number of pictures in the sequence of pictures minus one, inclusive. Therefore, each picture with an index value N for which N/8 is equal to 0 can be used as a random access point, in the sense that if the decoding starts from the picture, except for the initial seven pictures that cannot be fully correctly decoded, all pictures afterwards can be correctly decoded.

In the above scenario, in picture 2 (and any picture with an index value N for which N/8 is equal to 2), it is ideal to disallow in-picture prediction as well as loop filtering across the tile boundary between tile 2 and tile 3, i.e., the boundary between the area to the left of the boundary, which is also referred to as the refreshed area, and the area to the right of the boundary, which is also referred to as the un-refreshed area. Generally, in picture N, it is idea to disallow in-picture prediction as well as loop filtering across the tile boundary between tile N/8 and tile N/8+1, and to allow in-picture prediction as well as loop filtering across other tile boundaries. This way, a clean and efficient gradual decoding refresh or gradual random access functionality can be provided.

In the second scenario, each picture in a sequence of pictures is partitioned into more than one tile, and a subset of the tiles covers the same rectangular region in all the pictures, and the region for all the pictures can be decoded independently of other region from the same picture and other pictures. Such a region is also referred to as an independently decodable sub-picture, which can be the only region desired by some clients due to restrictions such as decoding capability and network bandwidth as well as user preferences. In such a scenario, it is ideal to disallow in-picture prediction as well as loop filtering across the tile boundaries that are also the boundaries of the independently decodable sub-picture. This way, a clean and efficient region of interest (ROI) coding can be provided.

This disclosure provides techniques for signaling whether cross-tile-boundary loop filtering operations are allowed, in addition to whether tile boundaries are to be considered independent for prediction operations. Accordingly, this disclosure introduces a new syntax element, referred to in this disclosure as “tile_boundary_loop_filtering_idc,” for controlling cross-tile-boundary loop filtering. Loop filtering operations generally include any of deblocking filtering, ALF, and SAO. In general, deblocking filtering is selectively applied at edges of blocks to reduce blockiness artifacts, ALF is applied based on pixel classifications, and SAO is used to modify direct current (DC) values.

In accordance with the techniques of this disclosure, a value may be signaled indicating whether loop filtering operations are allowed across tile boundaries, e.g., for one or more particular boundaries or for all tiles within a frame or within a sequence. Such values may be signaled in a sequence parameter set (SPS) or a picture parameter set (PPS). The SPS applies to a sequence of pictures, while the PPS applies to individual pictures. In instances where cross-tile-boundary loop filtering is not allowed, other types of loop filtering that do not utilize values across a tile boundary may be used.

In some examples, finer grain control of cross-tile-boundary loop filtering operations may be achieved by using additional signaled values. For example, when a first value indicates that cross-tile-boundary loop filtering operations are allowed, additional values may signal specifically whether cross-tile-boundary loop filtering operations are allowed (or not allowed) for horizontal tile boundaries and/or vertical tile boundaries. As another example, when a first value indicates that cross-tile-boundary loop filtering operations are allowed, additional values may signal specifically for which tile boundaries loop filtering operations are allowed (or not allowed). For example, the specific tile boundaries may be identified using pairs of tile indexes. In addition or in the alternative, in some examples, a value may be signaled in a slice header that indicates whether cross-tile-boundary loop filtering is allowed (or not allowed) for tile boundaries touched by the slice.

As will be made clear in some of the following example explanations, cross-tile-boundary loop filtering and performing loop filtering across tile boundaries generally refer to loop filtering operations that utilize information associated with at least two different pixels or two different blocks that are in different tiles. When cross-tile-boundary loop filtering is disabled (e.g. not allowed), loop filtering operations that utilize information from pixels or blocks of only one tile may be performed, but loop filtering operations that utilize information from pixels or blocks of more than one tile may not be disabled.

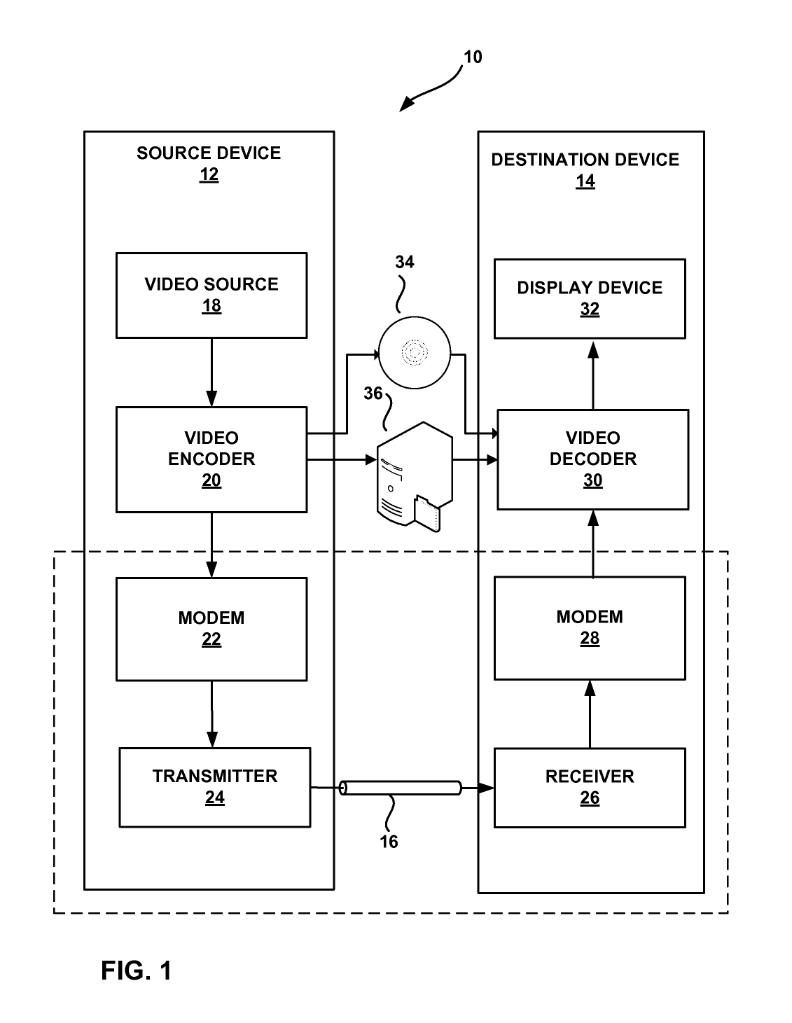

FIG. 1 is a block diagram illustrating an example video encoding and decoding system 10 that may be configured to allow and disallow loop filtering operations across tile boundaries in accordance with examples of this disclosure. As shown in FIG. 1, the system 10 includes a source device 12 that transmits encoded video to a destination device 14 via a communication channel 16. Encoded video data may also be stored on a storage medium 34 or a file server 36 and may be accessed by the destination device 14 as desired. When stored to a storage medium or file server, video encoder 20 may provide coded video data to another device, such as a network interface, a compact disc (CD), Blu-ray or digital video disc (DVD) burner or stamping facility device, or other devices, for storing the coded video data to the storage medium. Likewise, a device separate from video decoder 30, such as a network interface, CD or DVD reader, or the like, may retrieve coded video data from a storage medium and provided the retrieved data to video decoder 30.

The source device 12 and the destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In many cases, such devices may be equipped for wireless communication. Hence, the communication channel 16 may comprise a wireless channel, a wired channel, or a combination of wireless and wired channels suitable for transmission of encoded video data. Similarly, the file server 36 may be accessed by the destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server.

Techniques for controlling loop filtering across tile boundaries, in accordance with examples of this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, the system 10 may be configured to support one-way or two-way video transmission to support applications such as video streaming, video playback, video broadcasting, and/or video telephony.

In the example of FIG. 1, the source device 12 includes a video source 18, a video encoder 20, a modulator/demodulator 22 and a transmitter 24. In the source device 12, the video source 18 may include a source such as a video capture device, such as a video camera, a video archive containing previously captured video, a video feed interface to receive video from a video content provider, and/or a computer graphics system for generating computer graphics data as the source video, or a combination of such sources. As one example, if the video source 18 is a video camera, the source device 12 and the destination device 14 may form so-called camera phones or video phones. However, the techniques described in this disclosure may be applicable to video coding in general, and may be applied to wireless and/or wired applications, or application in which encoded video data is stored on a local disk.

The captured, pre-captured, or computer-generated video may be encoded by the video encoder 20. The encoded video information may be modulated by the modem 22 according to a communication standard, such as a wireless communication protocol, and transmitted to the destination device 14 via the transmitter 24. The modem 22 may include various mixers, filters, amplifiers or other components designed for signal modulation. The transmitter 24 may include circuits designed for transmitting data, including amplifiers, filters, and one or more antennas.

The captured, pre-captured, or computer-generated video that is encoded by the video encoder 20 may also be stored onto a storage medium 34 or a file server 36 for later consumption. The storage medium 34 may include Blu-ray discs, DVDs, CD-ROMs, flash memory, or any other suitable digital storage media for storing encoded video. The encoded video stored on the storage medium 34 may then be accessed by the destination device 14 for decoding and playback.

The file server 36 may be any type of server capable of storing encoded video and transmitting that encoded video to the destination device 14. Example file servers include a web server (e.g., for a website), an FTP server, network attached storage (NAS) devices, a local disk drive, or any other type of device capable of storing encoded video data and transmitting it to a destination device. The transmission of encoded video data from the file server 36 may be a streaming transmission, a download transmission, or a combination of both. The file server 36 may be accessed by the destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on a file server.

The destination device 14, in the example of FIG. 1, includes a receiver 26, a modem 28, a video decoder 30, and a display device 32. The receiver 26 of the destination device 14 receives information over the channel 16, and the modem 28 demodulates the information to produce a demodulated bitstream for the video decoder 30. The information communicated over the channel 16 may include a variety of syntax information generated by the video encoder 20 for use by the video decoder 30 in decoding video data. Such syntax may also be included with the encoded video data stored on the storage medium 34 or the file server 36. Each of the video encoder 20 and the video decoder 30 may form part of a respective encoder-decoder (CODEC) that is capable of encoding or decoding video data.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In the example of FIG. 1, the communication channel 16 may comprise any wireless or wired communication medium, such as a radio frequency (RF) spectrum or one or more physical transmission lines, or any combination of wireless and wired media. The communication channel 16 may form part of a packet-based network, such as a local area network, a wide-area network, or a global network such as the Internet. The communication channel 16 generally represents any suitable communication medium, or collection of different communication media, for transmitting video data from the source device 12 to the destination device 14, including any suitable combination of wired or wireless media. The communication channel 16 may include routers, switches, base stations, or any other equipment that may be useful to facilitate communication from the source device 12 to the destination device 14.

The video encoder 20 and the video decoder 30 may operate according to a video compression standard, such as the High Efficiency Video Coding (HEVC) standard presently under development, and may conform to the HEVC Test Model (HM). A recent draft of the HEVC standard, referred to as “HEVC Working Draft 8” or “WD8,” is described in document JCTVC-J1003, Bross et al., “High efficiency video coding (HEVC) text specification draft 8,” Joint Collaborative Team on Video Coding (JCT-VC) of ITU-T SG16 WP3 and ISO/IEC JTC1/SC29/WG11, 10th Meeting: Stockholm, SE 11-20 Jul. 2012, which, as of 17 Oct. 2012, is downloadable from http://phenix.int-evry.fr/jct/doc_end_user/documents/10_Stockholm/wg11/JCTVC-J1003-v8.zip.

Alternatively, the video encoder 20 and the video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples include MPEG-2 and ITU-T H.263.

Although not shown in FIG. 1, in some aspects, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

The video encoder 20 may implement any or all of the techniques of this disclosure for controlling loop filtering across tile boundaries in a video coding process. Likewise, the video decoder 30 may implement any or all of these techniques for adaptive loop filtering in a video coding process. A video coder, as described in this disclosure, may refer to a video encoder or a video decoder. Similarly, a video coding unit may refer to a video encoder or a video decoder. Likewise, video coding may refer to video encoding or video decoding.

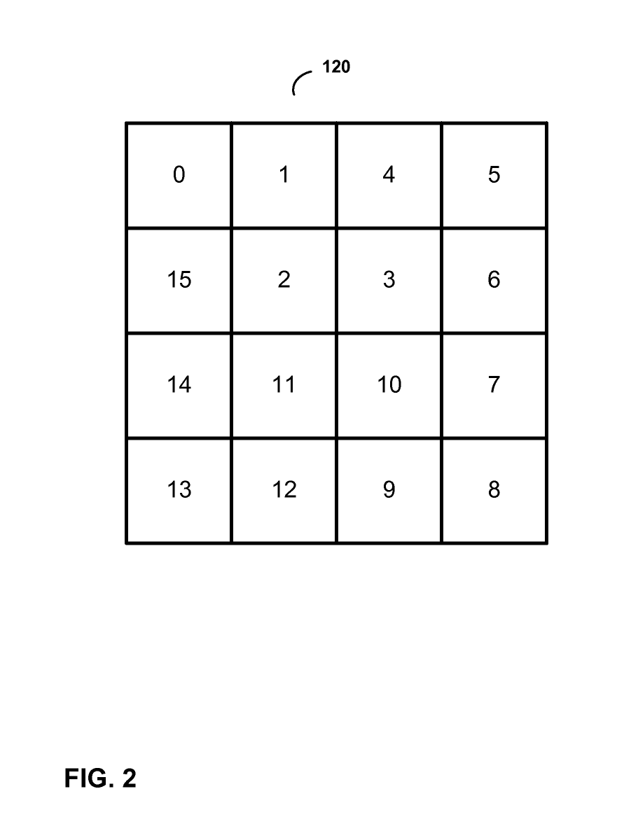

In the current ALF proposed for HEVC, two adaptation modes (i.e., block and region adaptation modes) are proposed. For region adaptive mode, a frame is divided into 16 regions, and each region can have one set of linear filter coefficients (a plurality of AC coefficients and one DC coefficient) and one region can share the same filter coefficients with other regions. FIG. 2 is a conceptual diagram showing region-based classification for an adaptive loop filter. As shown in FIG. 2, frame 120 is divided into 16 regions. Each of these 16 regions is represented by a number (0-15) that indicates the particular set of linear filter coefficients used by that region. The numbers (0-15) may be index numbers to a predetermined set of filter coefficients that are stored at both a video encoder and a video decoder. In one example, a video encoder may signal, in the encoded video bitstream, the index number of the set of filter coefficients used by the video encoder for a particular region. Based on the signaled index, a video decoder may retrieve the same predetermined set of filter coefficients to use in the decoding process for that region. In other examples, the filter coefficients are signaled explicitly for each region.

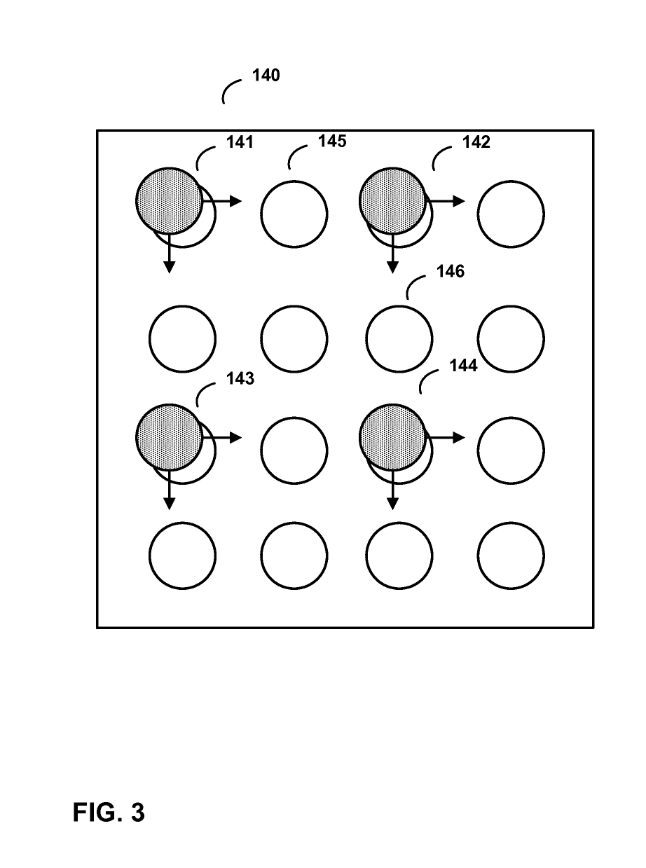

For block based mode, a frame is divided in to 4×4 blocks, and each 4×4 block derives one class by computing a metric using direction and activity information. For each class, one set of linear filter coefficients (a plurality of AC coefficients and one DC coefficient) can be used and one class can share the same filter coefficients with other classes. FIG. 3 is a conceptual diagram showing block-based classification for an adaptive loop filter.

The computation of the direction and activity, and the resulting metric based on direction and activity, are shown below:

Direction

Ver(i,j)=abs(X(i,j)<<1−X(i,j−1)−X(i,j+1))

Hor(i,j)=abs(X(i,j)<<1−X(i−1,j)−X(i+1,j))

H_{B}=Σ_{i=0,2}Σ_{j=0,2}H(i,j)

V_{B}=Σ_{i=0,2}Σ_{j=0,2}V(i,j)

Direction=0,1(H_{B}>2V_{B}),2(V_{B}>2H_{B})

Activity

L_{B}=H_{B}+V_{B}
5 classes (0, 1, 2, 3, 4)

Metric

Activity+5*Direction

Hor_act (i, j) generally refers to the horizontal activity of current pixel (i, j), and Vert_act(i, j) generally refers to the vertical activity of current pixel (i,j). X(i, j) generally refers to a pixel vale of pixel (i, j). H_{B} refers to the horizontal activity of the 4×4 block, which, in the example of FIG. 3, is determined based on a sum of horizontal activity for pixels (0, 0), (0, 2), (2, 0), and (2, 2). V_{B} refers to the vertical activity of the 4×4 block, which in this example is determined based on a sum of vertical activity for pixels (0, 0), (0, 2), (2, 0), and (2, 2). “<<1” represents a multiply by two operation. Based on the values of H_{B} and V_{B}, a direction can be determined. As one example, if the value of H_{B} is more than 2 times the value of V_{B}, then the direction can be determined to be direction 1 (i.e. horizontal), which might correspond to more horizontal activity than vertical activity. If the value of V_{B} is more than 2 times the value of H_{B}, then the direction can be determined to be direction 2 (i.e. vertical), which might correspond to more vertical activity than horizontal activity. Otherwise, the direction can be determined to be direction 0 (i.e. no direction), meaning neither horizontal nor vertical activity is dominant. The labels for the various directions and the ratios used to determine the directions merely constitute one example, as other labels and ratios can also be used.

Activity (L_{B}) for the 4×4 block can be determined as a sum of the horizontal and vertical activity. The value of L_{B} can be classified into a range. This particular example shows five ranges, although more or fewer ranges may similarly be used. Based on the combination of activity and direction, a filter for the 4×4 block of pixels can be selected. As one example, a filter may be selected based on a two-dimensional mapping of activity and direction to filters, or activity and direction may be combined into a single metric, and that single metric may be used to select a filter (e.g., the metric=Activity+5*Direction).

Returning to FIG. 3, block 140 represents a 4×4 block of pixels. In this example, only four of the sixteen pixels are used to calculate activity and direction metrics for a block-based ALF. The four pixels are pixel (0, 0) which is labeled as pixel 141, pixel (2, 0) which is labeled as pixel 142, pixel (0, 2) which is labeled as pixel 143, and pixel (2, 2) which is labeled as pixel 144. The Horizontal activity of pixel 141 (i.e., hor_act(0, 0)), for example, is determined based on a left neighboring pixel and a right neighboring pixel. The right neighboring pixel is labeled as pixel 145. The left neighboring pixel is located in a different block than the 4×4 block and is not shown in FIG. 3. The vertical activity of pixel 142 (i.e. ver_act(2, 0)), for example is determined based on an upper neighboring pixel and a lower neighboring pixel. The lower neighboring pixel is labeled as pixel 146, and the upper neighboring pixel is located in a different block than the 4×4 block and is not shown in FIG. 3. Horizontal and vertical activity may be calculated for pixels 143 and 144 in a similar manner.

As is currently proposed in the HEVC standard, the ALF is performed along with other loop filters (e.g., deblocking and SAO). Filters may be said to be performed “in loop” when the filters are applied by a video coding device to video data that is stored for future reference. In this manner, in-loop filtered video data may be used for reference by subsequently coded video data. Moreover, both a video encoder and a video decoder may be configured to perform substantially the same filtering process. The loop filters may, for example, be processed in a particular order, such as deblocking followed by SAO followed by ALF, although other orders may also be used. In the current working draft of HEVC, each of the loop filters are frame based. However, if any of the loop filters are applied at the slice level (including an entropy slice) or at the tile level, special handling may be beneficial at the slice and tile boundaries.

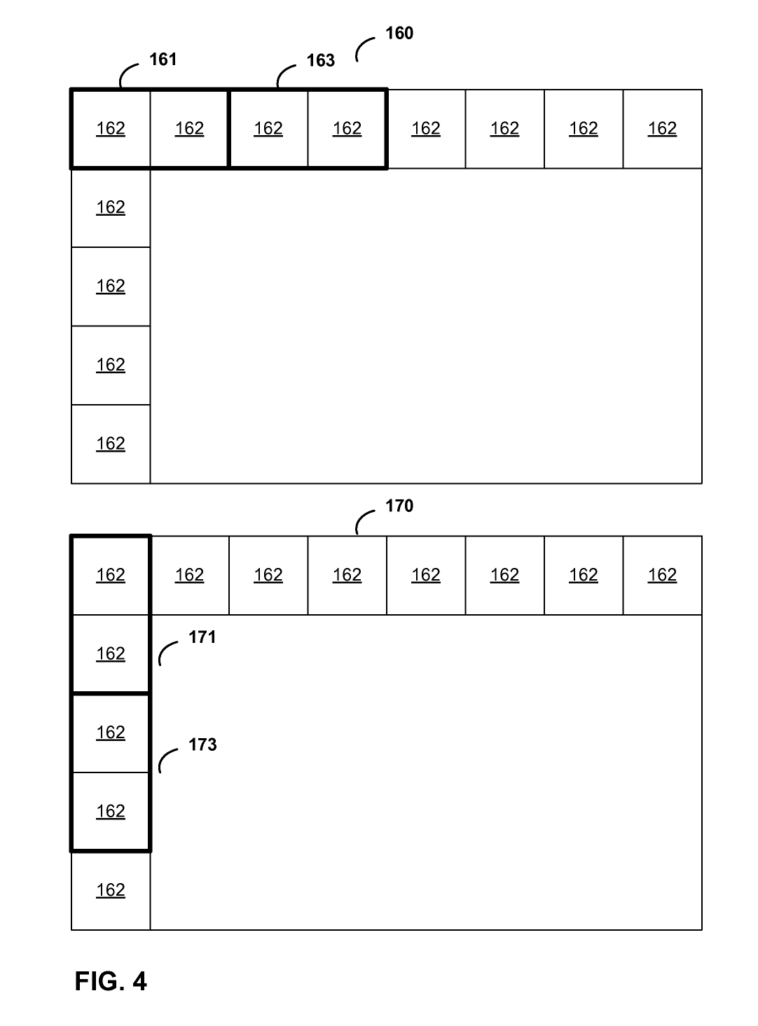

FIG. 4 is a conceptual diagram showing example tiles of a frame. Frame 160 may be divided into multiple largest coding units (LCU) 162. Two or more LCUs may be grouped into a rectangular-shaped tiles. When tile-based coding is enabled, coding units within each tile are coded (i.e., encoded or decoded) together before coding subsequent tiles. As shown for frame 160, tiles 161 and 163 are oriented in a horizontal manner and have both horizontal and vertical boundaries. As shown for frame 170, tiles 171 and 173 are oriented in a vertical manner and have both horizontal and vertical boundaries.

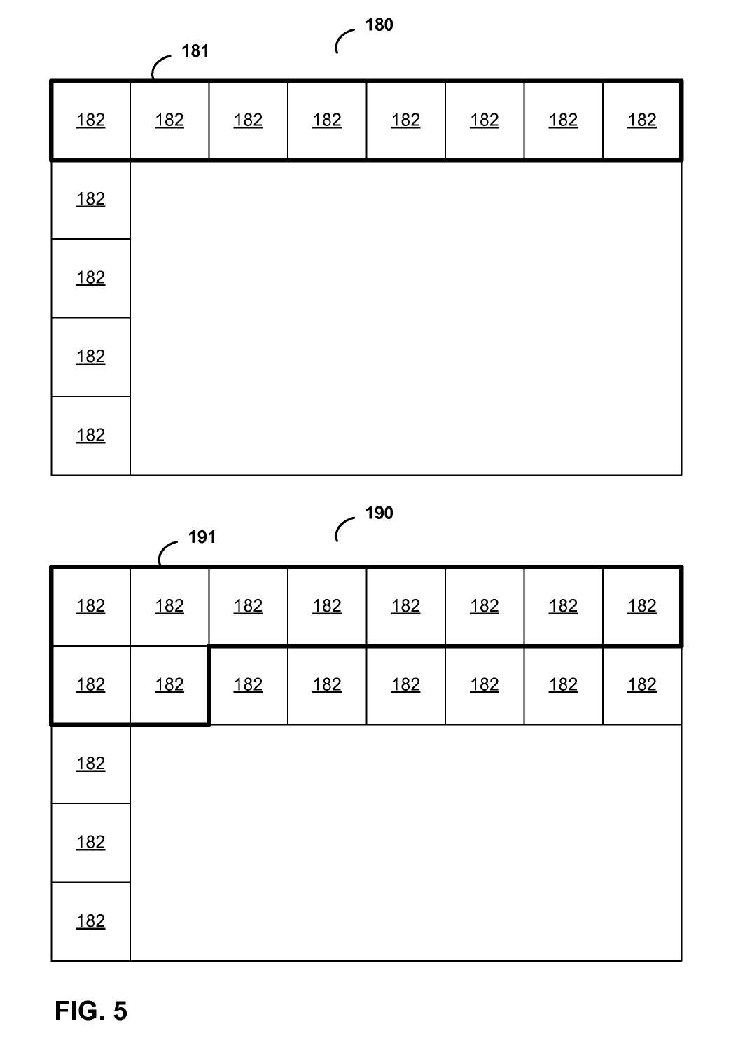

FIG. 5 is a conceptual diagram showing examples slices of a frame. Frame 180 may be divided into a slice which consists of multiple consecutive LCUs (182) in raster scan order across the frame. In some examples, a slice may have a uniform shape (e.g., slice 181) and encompass one or more complete rows of LCUs in a frame. In other examples, a slice is defined as a specific number of consecutive LCUs in raster scan order, and may exhibit a non-uniform shape. For example, frame 190 is divided into a slice 191 that consists of 10 consecutive LCUs (182) in raster scan order. As frame 190 is only 8 LCUs wide, an additional two LCUs in the next row are included in slice 191.

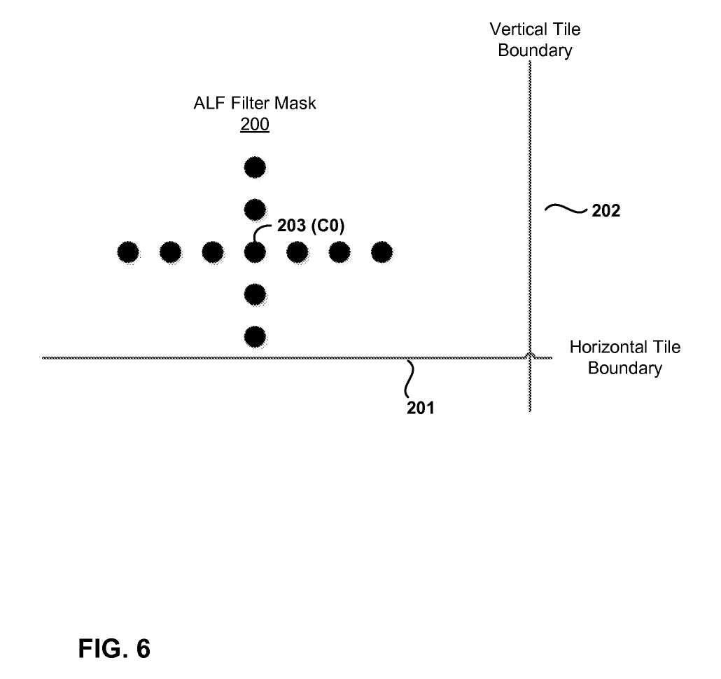

FIG. 6 is conceptual diagram depicting an adaptive loop filter at slice and tile boundaries. Horizontal slice and/or tile boundary 201 is depicted as a horizontal line and vertical tile boundary 202 is depicted as a vertical line. The circles of filter mask 200 in FIG. 3 represent coefficients of the filter, which are applied to pixels of the reconstructed video block in the slice and/or tile. That is, the value of a coefficient of the filter may be applied to the value of a corresponding pixel. Assuming that the center of the filter is positioned at the position of (or in close proximity to) the pixel to be filtered, a filter coefficient may be said to correspond to a pixel that is collocated with the position of the coefficient. Pixels corresponding to coefficients of a filter can also be referred to as “supporting pixels” or collectively, as a “set of support” for the filter. The filtered value of a current pixel 203 (corresponding to the center pixel mask coefficient C0) is calculated by multiplying each coefficient in the filter mask 200 by the value of its corresponding pixel, and summing each resulting value.

In this disclosure, the term “filter” generally refers to a set of filter coefficients. For example, a 3×3 filter may be defined by a set of 9 filter coefficients, a 5×5 filter may be defined by a set of 25 filter coefficients, a 9×5 filter may be defined by a set of 45 filter coefficients, and so on. Filter mask 200 shown in FIG. 6 is a 7×5 filter having 7 filter coefficients in the horizontal direction and 5 filter coefficients in the vertical direction (the center filter coefficient counting for each direction), however any number of filter coefficients may be applicable for the techniques of this disclosure. The term “set of filters” generally refers to a group of more than one filter. For example, a set of two 3×3 filters, could include a first set of 9 filter coefficients and a second set of 9 filter coefficients. The term “shape,” sometimes called the “filter support,” generally refers to the number of rows of filter coefficients and number of columns of filter coefficients for a particular filter. For example, 9×9 is an example of a first shape, 7×5 is an example of a second shape, and 5×9 is an example of a third shape. In some instances, filters may take non-rectangular shapes including diamond-shapes, diamond-like shapes, circular shapes, circular-like shapes, hexagonal shapes, octagonal shapes, cross shapes, X-shapes, T-shapes, other geometric shapes, or numerous other shapes or configuration. The example in FIG. 6 is a cross shape, however other shape may be used.

This disclosure introduces techniques for controlling loop filtering, including deblocking filtering, ALF, and SAO filtering, across tile boundaries. This disclosure will explain certain techniques using examples. Some of these example may reference only one type of loop filtering, such as ALF, but it should be understood that the techniques of this disclosure may also be applied to other types of loop filters, as well as to various combinations of loop filters.

As part of controlling loop filtering, video encoder 20 may include in a coded bitstream a value for a syntax element indicating if loop filtering is enabled across tile boundaries, e.g., for one or more particular boundaries or for all tiles within a frame or within a sequence. In some examples, video encoder 20 may exercise finer grain control of cross-tile-boundary loop filtering operations by signaling in the bitstream additional signaled values. For example, when a first syntax element indicates that cross-tile-boundary loop filtering operations are allowed, video encoder 20 may signal in the bitstream additional values indicating whether cross-tile-boundary loop filtering operations are allowed (or not allowed) for horizontal tile boundaries and/or vertical tile boundaries. As another example, when a first value indicates that cross-tile-boundary loop filtering operations are allowed, video encoder 20 may signal in the bitstream additional values to identify specifically for which tile boundaries loop filtering operations are allowed (or not allowed). For example, the specific tile boundaries may be identified using one or more tile indexes of tiles adjacent to the tile boundary. In another example, video encoder 20 may include a series of flags in the bitstream, with each flag corresponding to a particular boundary and the value of the flag indicating if cross-tile-boundary loop filtering operations are allowed across that particular boundary. In addition or in the alternative, in some examples, a value may be signaled in a slice header that indicates whether cross-tile-boundary prediction is allowed (or not allowed) for tile boundaries touched by the slice.

As discussed above, in some scenarios loop filtering may be disabled across tile boundaries. One reason loop filtering may be disabled across tile boundaries is because, pixels in neighboring tiles may not have already been coded, and as such, would be unavailable for use with some filter masks. In instances where loop filtering is disabled across tile boundaries, loop filtering operations that do not cross tile boundaries may still be performed. In these cases, padded data may be used for unavailable pixels (i.e., pixels that are on the other side of the slice or tile boundary from the current slice or tile) and filtering may be performed.

Additionally, this disclosure proposes techniques for performing ALF across tile boundaries when cross-tile loop filtering is disabled without using padded data. In general, this disclosure proposes using partial filters around tile boundaries. A partial filter is a filter that does not use one or more filter coefficients that are typically used for the filtering process. In one example, this disclosure proposes using partial filters where at least the filter coefficients corresponding to pixels on the other side of a tile boundary are not used, where the other side generally refers to the side of the tile boundary that is located across the boundary from where the pixel or group of pixels being filtered is located.

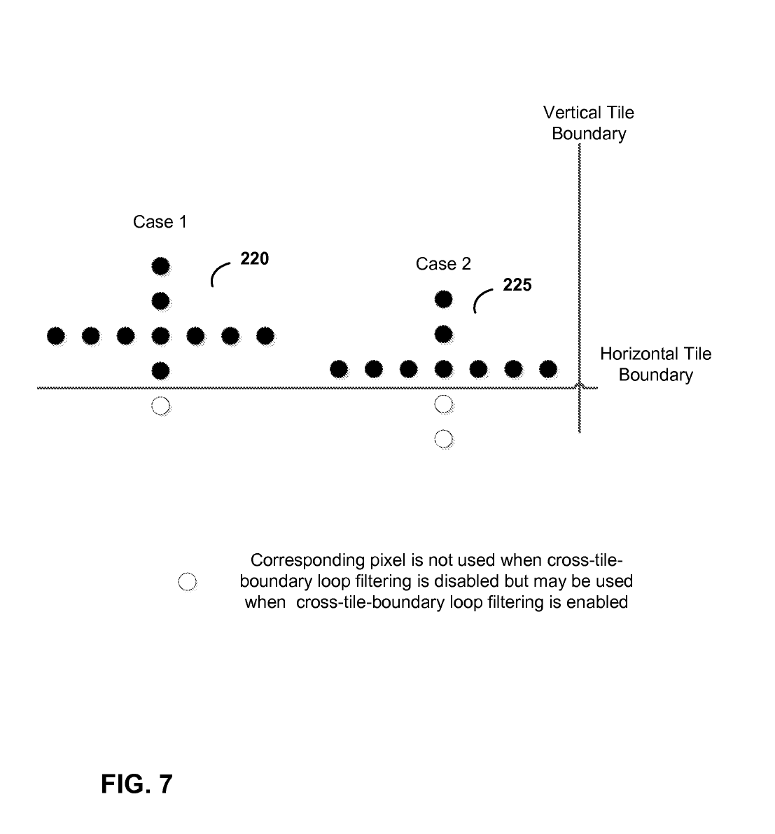

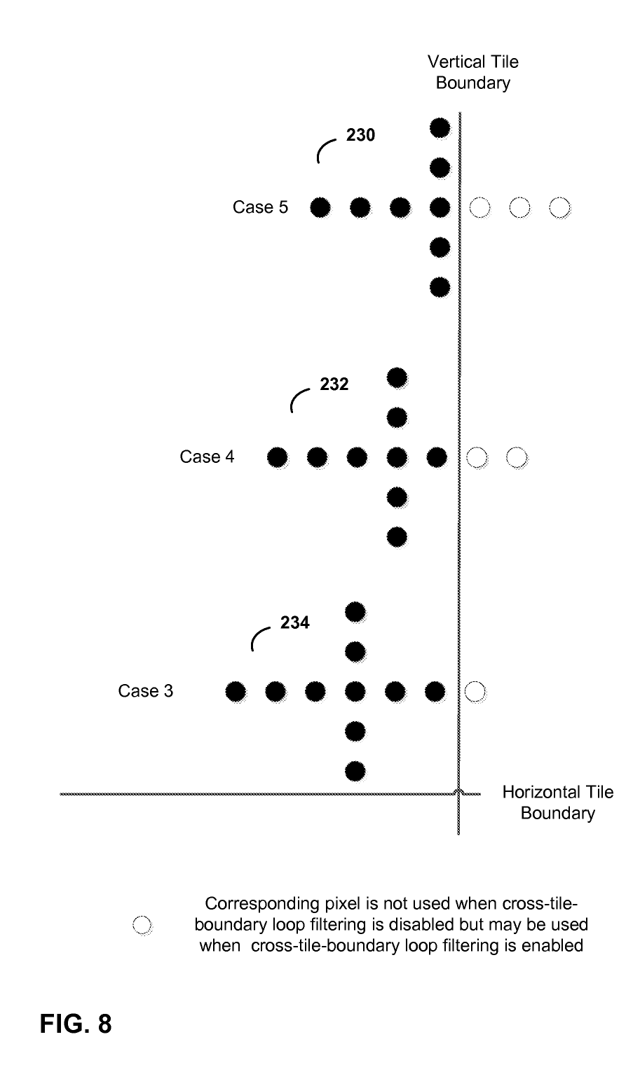

FIGS. 7 and 8 show examples of filter masks that span across at least one tile boundary. When cross-tile-boundary loop filtering is enabled for a particularly tile boundary, all the filter support positions shown (i.e. filter support positions corresponding to both the black circles and the white circles in FIGS. 7 and 8) may be used for a filtering operation. When cross-tile-boundary loop filtering is disabled for a particularly tile boundary, the filter support positions across tile boundaries (i.e. filter support positions corresponding to the white circles in FIGS. 7 and 8) are not used for loop filter operation, but the filter support positions that do not cross tile boundaries (i.e. the filter support positions corresponding to the black circles in FIGS. 7 and 8) may be used.

In one example, asymmetric partial filters can be used near tile boundaries. FIG. 7 is conceptual diagram depicting asymmetric partial filters at a horizontal boundary. FIG. 8 is conceptual diagram depicting asymmetric partial filters at a vertical boundary. In this approach, when filtering across tile boundaries is disabled, only available pixels (i.e., pixels within the current tile) are used for filtering. Filter taps outside the tile boundary are skipped. As such, no padded pixel data is used. The filters in FIG. 7 and FIG. 8 are referred to as asymmetric because there are more filter taps used on one side (either the horizontal or vertical side) of the center of the filter mask then the other. As the entire filter mask is not used, the filter coefficients may be renormalized to produce the desired results. Techniques for renormalization will be discussed in more detail below.

In Case 1 of FIG. 7, the center of filter mask 220 is one row of pixels away from a horizontal tile boundary. Since filter mask 220 is a 7×5 filter, one filter coefficient in the vertical direction corresponds to a pixel that is across the horizontal boundary. This filter coefficient is depicted in white. If cross-tile-boundary loop filtering is enabled, then the pixel across the tile boundary may be used for a loop filtering operation. If cross-tile-boundary loop filtering is disabled, then the pixel corresponding to the white filter coefficient may not be used in filtering.

Likewise, in Case 2, the center of filter mask 225 is on a row of pixels adjacent the horizontal tile boundary. In this case, two filter coefficients correspond to pixels that are across the horizontal boundary. As such, if cross-tile-boundary loop filtering is disabled, then neither of the two white filter coefficients in filter mask 225 is used for loop filtering. If cross-tile-boundary loop filtering is enabled, then both the pixels across the tile boundary and their corresponding filter coefficients may be used for a loop filtering operation. In both Case 1 and Case 2, all black filter coefficients are used regardless of whether cross-tile-boundary loop filtering is enabled or disabled.

In case 3 of FIG. 8, the center of filter mask 234 is two columns of pixels away from a vertical tile boundary. Since filter mask 234 is a 7×5 filter, one filter coefficient in the horizontal direction corresponds to a pixel that is across the vertical boundary. Again, this filter coefficient is depicted in white. If cross-tile-boundary loop filtering is enabled, then the pixel across the tile boundary and its corresponding filter coefficient may be used for a loop filtering operation. If cross-tile-boundary loop filtering is disabled, then the pixel across the tile boundary and its corresponding filter coefficient may not be used in filtering.

Similarly, in Case 4, the center of filter mask 232 is one column of pixels away from a vertical tile boundary. In this case, two filter coefficients correspond to pixels that over the vertical boundary. If cross-tile-boundary loop filtering is enabled, then the two pixels across the tile boundary and their corresponding filter coefficients may be used for a loop filtering operation. If cross-tile-boundary loop filtering is disabled, then the two pixels across the tile boundary and their corresponding filter coefficients may not be used in filtering.

In Case 5, the center of filter mask 230 is on a column of pixels adjacent the vertical tile boundary. In this case, three filter coefficients correspond to pixels that are across the vertical boundary. If cross-tile-boundary loop filtering is enabled, then the three pixels across the tile boundary and their corresponding filter coefficients may be used for a loop filtering operation. If cross-tile-boundary loop filtering is disabled, then the three pixels across the tile boundary and their corresponding filter coefficients may not be used in filtering. In all of Case 3, 4, and 5 all black filter coefficients are used regardless of whether cross-tile-boundary loop filtering is enabled or disabled.

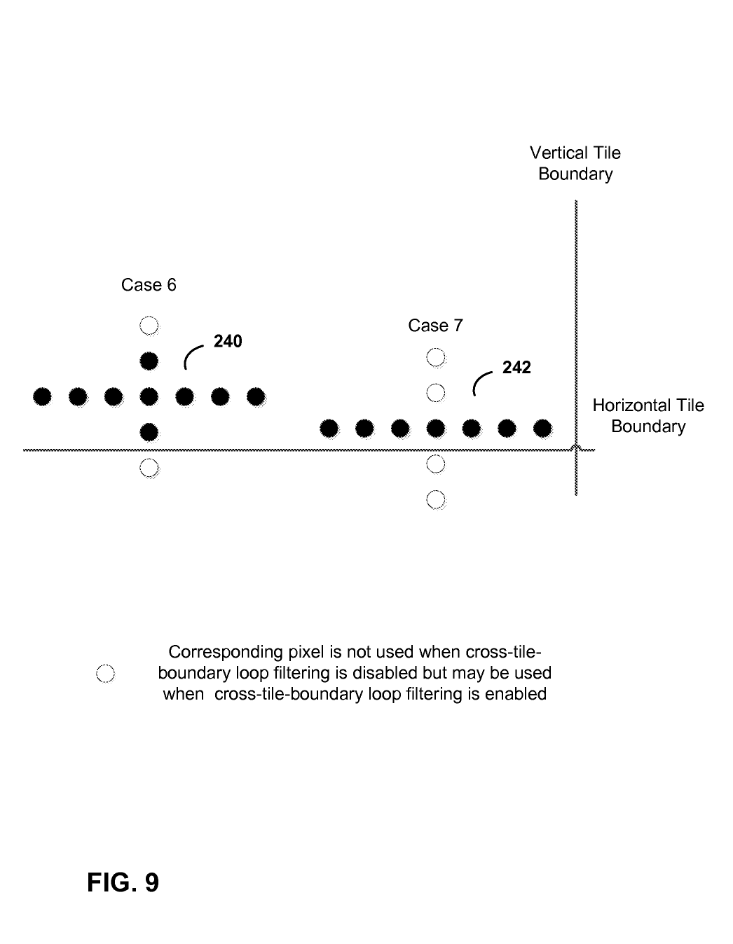

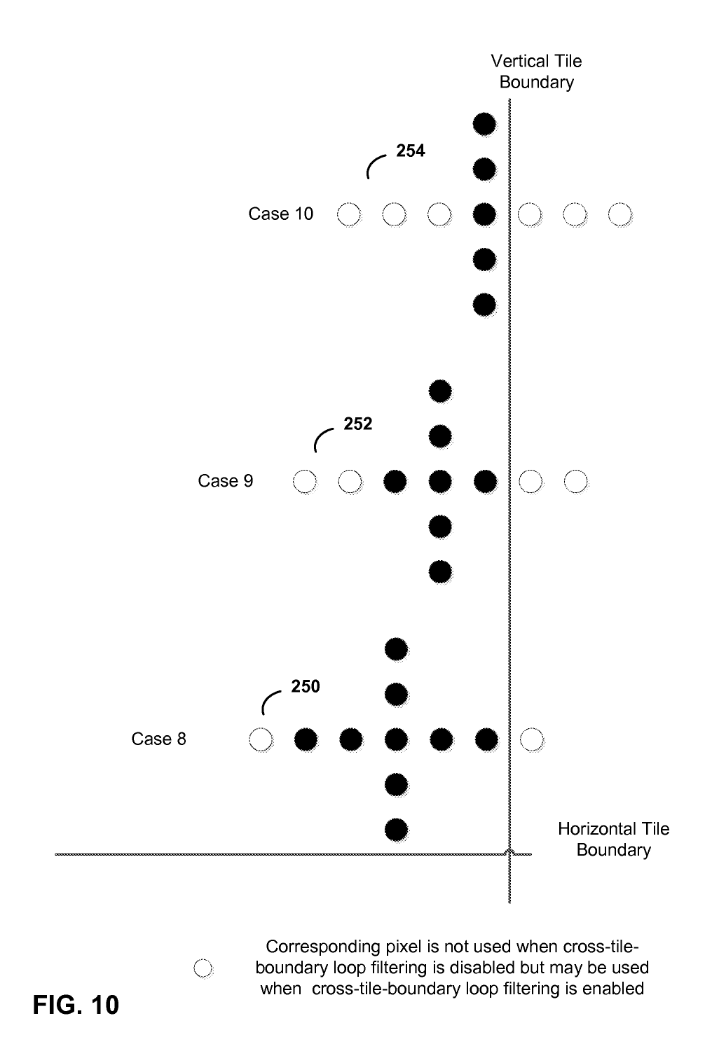

In another example, symmetric partial filters can be used near tile boundaries when cross-tile-boundary loop filtering is disabled. FIG. 9 is conceptual diagram depicting symmetric partial filters at a horizontal boundary. FIG. 10 is conceptual diagram depicting symmetric partial filters at a vertical boundary. As with asymmetric partial filters like those shown FIGS. 7 and 8, in this approach, pixels that lie across a tile boundary and their corresponding filter coefficients are not used for a loop filtering operation when cross-tile-boundary loop filtering is disabled, but also, some coefficients of the filter mask that correspond to pixels not across the tile boundary are also not used, so as to retain a symmetrical filter mask.

For example, in Case 6 of FIG. 9, one filter coefficient in filter mask 240 is across the horizontal slice or tile boundary. The corresponding filter coefficient within the horizontal boundary on the other side of the filter mask is also not used when cross-tile-boundary loop filtering is disabled. In this way, a symmetrical arrangement of coefficients in the vertical direction around the center coefficient is preserved. In Case 7 of FIG. 9, two filter coefficients in filter mask 242 are across the horizontal boundary. The corresponding two filter coefficients on the other side of the center filter coefficient within the horizontal boundary are also not used when cross-tile-boundary loop filtering is disabled. Similar examples are shown in FIG. 10 for the vertical tile boundary. In case 8, one filter coefficient corresponds to a pixel across the vertical tile boundary. This coefficient, as well as another pixel at the left side of the horizontal part of filter mask 250, are not used when cross-tile-boundary loop filtering is disabled. Similar, filter mask adjustments are made for filter masks 252 and 254 in the case where two (Case 9) and four (Case 10) filter coefficients correspond to pixel across the vertical boundary.

Like the asymmetric partial filters shown in FIG. 7 and FIG. 8, the entire filter mask is not used for the symmetric partial filters when cross-tile-boundary loop filtering is disabled. Accordingly, the filter coefficients may be renormalized. Techniques for renormalization will be discussed in more detail below. In instances, where cross-tile-boundary loop filtering is enabled all filter coefficients shown in FIGS. 9 and 10 (i.e. both the white filter coefficients and the black filter coefficients) may be used for performing a loop filtering operation.

Whether or not to apply a partial filter (e.g., asymmetric partial filter or symmetric partial filter) can be an adaptive decision. For the examples shown in FIG. 7 and FIG. 9, a partial filter may be used for Case 1 and Case 6, but not for Case 2 and Case 7. It may not be preferable to use partial filters for Case 2 and Case 7 because the number of unused filter coefficients is larger. Instead, other techniques described below (e.g., mirror padding, skipping filtering, etc.) can be used for Case 2 and Case 7. Likewise, for the examples shown in FIG. 8 and FIG. 10, the use of partial filtering may be applicable for Cases 3, 4, 8, and 9, but not for Cases 5 and 10.

The decision to use a partial filter can also be based on other criteria. For example, a partial filter may not be used when the number of coefficients whose corresponding pixels are not available is greater than some threshold. A partial filter may not be used when the sum of the coefficient values whose corresponding pixels are not available is greater than some threshold. As another example, a partial filter may not be used when the sum of the absolute values of the coefficient values whose corresponding pixels are not available is greater than some threshold.

Number of coefficients whose according pixels are not available>Th1

Sum (coefficients whose according pixels are not available)>Th2

Sum (abs(coefficients whose according pixels are not available))>Th3.

A subset of the above conditions can be chosen to decide whether to apply partial filter for specific slice of tile boundaries.

In another example of the disclosure, partial filtering may only be enabled for horizontal tile boundaries, while at vertical boundaries, however, loop filtering is skipped entirely. More specifically, in one example, if a video coder determines that a filter mask will use pixels on the other side of a vertical tile boundary, loop filtering will be skipped for that pixel. In other examples, if a video coder determines that a filter mask will use pixels on the other side of a vertical tile boundary for one or more pixels in a coding unit, ALF will be skipped for the entire coding unit. In another example of the disclosure, in all boundaries, ALF may be skipped entirely.

In other examples of the disclosure, additional techniques may be applied at tile boundaries when partial filtering is not used. In one example, the ALF may use mirrored padded pixels on the other side of a slice or tile boundary, rather than using repetitively padded pixels. Mirrored pixels reflect the pixel values on the inside of the slice or tile boundary. For example, if the unavailable pixel is adjacent the tile or slice boundary, it would take the value (i.e., mirror) of the pixel on the inside of the tile or slice boundary that is also adjacent the boundary. Likewise, if the unavailable pixel is one row or column away from the tile or slice boundary, it would take the value (i.e., mirror) of the pixel on the inside of the tile or slice boundary that is also one row or column away from the boundary, and so forth.

In another example, the filtered values for pixels on the other side of a tile or slice boundary may be calculated according to the following equation: a*ALF using padded data+b*pre-filtered output where a+b=1. That is, padded pixels (i.e., pixels added to the other side of the slice or tile boundary) are multiplied by the ALF coefficient corresponding to the padded pixel and by a constant “a.” This value is then added to the multiplication of the pre-filtered padded pixel value and a constant “b,” where a+b=1.

Renormalization of filter coefficients for symmetric and asymmetric partial filter can be achieved in different ways. Consider an example where the original filter coefficients are labeled as C_1, . . . , C_N, where C is the value of a particular coefficient. Now assume that the C_1, . . . . , C_M coefficients do not have available corresponding pixels (i.e., the corresponding pixels are across a slice or tile boundary). Renormalized filter coefficients can be defined as follows:

### Example 1

Coeff_all=C_{—}1+C_{—}2+ . . . +C_{—}N

Coeff_part=Coeff_all−(C_{—}1+ . . . +C_{—}M)

New_coeffs C_{—}i′=C_{—}i*Coeff_all/Coeff_part, i=M+1, . . . , N

In example 1, Coeff_all represents the value of all coefficients in a filter mask summed together. Coeff_part represents the value of all coefficients in a partial filter mask. That is, the summed value of the coefficients corresponding to unavailable pixels (C_1+ . . . +C_M) are subtracted from the sum of all possible coefficients in the filter mask (Coeff_all). New_coeffs_Ci′ represents the value of the filter coefficients in the partial coefficients after a renormalization process. In Example one above, the value of the coefficient remaining in the partial filter is multiplied the total value of all possible coefficients in the filter mask (Coeff_all) and divided by the total value of all coefficients in the partial filter mask (Coeff_part).

Example 2 below shows another technique for renormalizing filter coefficients in a partial filter.

### Example 2

For subset of C_i, i=M+1, . . . , N, add C_k, k=1, . . . , M
For example,

C_(M+1)′=C_(M+1)+C_1, C_(M+2)′=C_(M+2)+C_{—}3, . . . or a.

C_{—}L′=C_{—}L+(C_{—}1+C_{—}2+ . . . +C_{—}M) b.

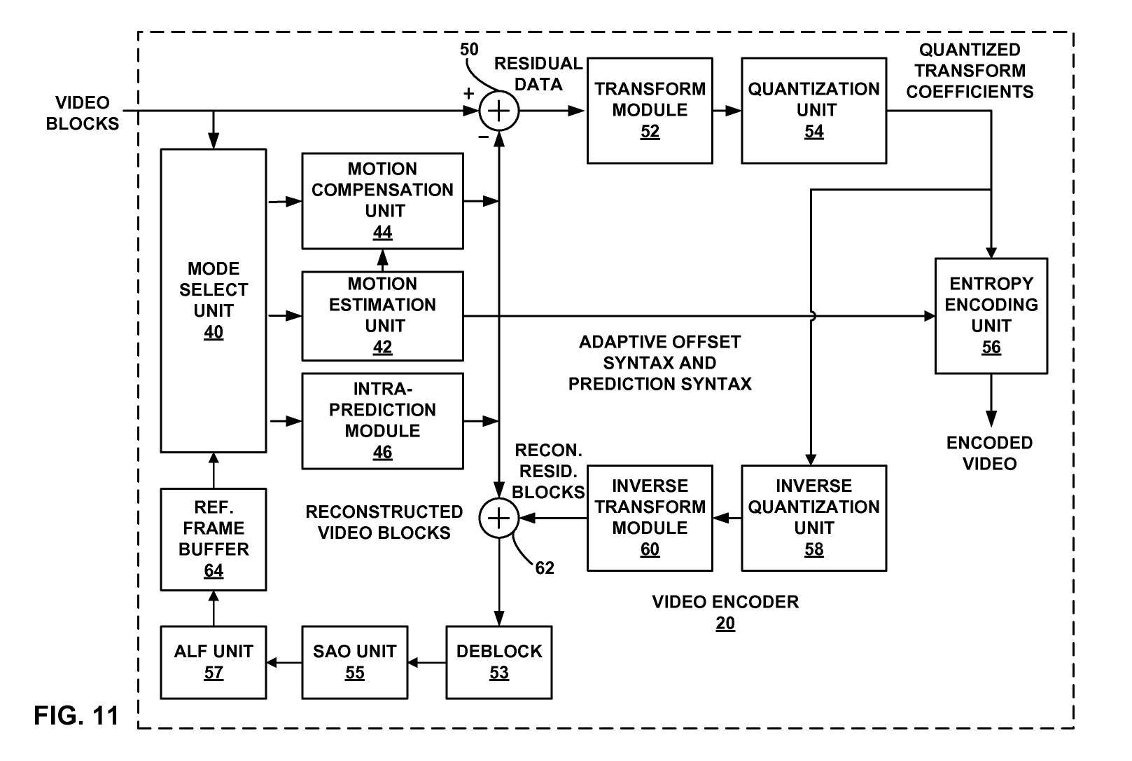

FIG. 11 is a block diagram illustrating an example of a video encoder 20 that may use techniques for controlling loop filtering across tile boundaries in a video coding process as described in this disclosure. The video encoder 20 will be described in the context of HEVC coding for purposes of illustration, but without limitation of this disclosure as to other coding standards or methods that may require adaptive loop filtering. The video encoder 20 may perform intra- and inter-coding of CUs within video frames. Intra-coding relies on spatial prediction to reduce or remove spatial redundancy in video data within a given video frame. Inter-coding relies on temporal prediction to reduce or remove temporal redundancy between a current frame and previously coded frames of a video sequence. Intra-mode (I-mode) may refer to any of several spatial-based video compression modes. Inter-modes such as uni-directional prediction (P-mode) or bi-directional prediction (B-mode) may refer to any of several temporal-based video compression modes.

As shown in FIG. 11, the video encoder 20 receives a current video block within a video frame to be encoded. In the example of FIG. 11, the video encoder 20 includes a motion compensation unit 44, a motion estimation unit 42, an intra-prediction module 46, a reference frame buffer 64, a summer 50, a transform module 52, a quantization unit 54, and an entropy encoding unit 56. The transform module 52 illustrated in FIG. 11 is the unit that applies the actual transform or combinations of transform to a block of residual data, and is not to be confused with block of transform coefficients, which also may be referred to as a transform unit (TU) of a CU. For video block reconstruction, the video encoder 20 also includes an inverse quantization unit 58, an inverse transform module 60, a summer 62, a deblocking filter 53, and SAO unit 55, and an ALF unit 57. Deblocking filter 53 may filter block boundaries to remove blockiness artifacts from reconstructed video. If desired, the deblocking filter would typically filter the output of the summer 62.

During the encoding process, the video encoder 20 receives a video frame or slice to be coded. The frame or slice may be divided into multiple video blocks, e.g., largest coding units (LCUs). The motion estimation unit 42 and the motion compensation unit 44 perform inter-predictive coding of the received video block relative to one or more blocks in one or more reference frames to provide temporal compression. The intra-prediction module 46 may perform intra-predictive coding of the received video block relative to one or more neighboring blocks in the same frame or slice as the block to be coded to provide spatial compression.

The mode select unit 40 may select one of the coding modes, intra or inter, e.g., based on rate distortion results for each mode, and provides the resulting intra- or inter-predicted block (e.g., a prediction unit (PU)) to the summer 50 to generate residual block data and to the summer 62 to reconstruct the encoded block for use in a reference frame. Summer 62 combines the predicted block with inverse quantized, inverse transformed data from inverse transform module 60 for the block to reconstruct the encoded block, as described in greater detail below. Some video frames may be designated as I-frames, where all blocks in an I-frame are encoded in an intra-prediction mode. In some cases, the intra-prediction module 46 may perform intra-prediction encoding of a block in a P- or B-frame, e.g., when motion search performed by the motion estimation unit 42 does not result in a sufficient prediction of the block.

The motion estimation unit 42 and the motion compensation unit 44 may be highly integrated, but are illustrated separately for conceptual purposes. Motion estimation (or motion search) is the process of generating motion vectors, which estimate motion for video blocks. A motion vector, for example, may indicate the displacement of a prediction unit in a current frame relative to a reference sample of a reference frame. The motion estimation unit 42 calculates a motion vector for a prediction unit of an inter-coded frame by comparing the prediction unit to reference samples of a reference frame stored in the reference frame buffer 64. A reference sample may be a block that is found to closely match the portion of the CU including the PU being coded in terms of pixel difference, which may be determined by sum of absolute difference (SAD), sum of squared difference (SSD), or other difference metrics. The reference sample may occur anywhere within a reference frame or reference slice, and not necessarily at a block (e.g., coding unit) boundary of the reference frame or slice. In some examples, the reference sample may occur at a fractional pixel position.

The motion estimation unit 42 sends the calculated motion vector to the entropy encoding unit 56 and the motion compensation unit 44. The portion of the reference frame identified by a motion vector may be referred to as a reference sample. The motion compensation unit 44 may calculate a prediction value for a prediction unit of a current CU, e.g., by retrieving the reference sample identified by a motion vector for the PU.

The intra-prediction module 46 may intra-predict the received block, as an alternative to inter-prediction performed by the motion estimation unit 42 and the motion compensation unit 44. The intra-prediction module 46 may predict the received block relative to neighboring, previously coded blocks, e.g., blocks above, above and to the right, above and to the left, or to the left of the current block, assuming a left-to-right, top-to-bottom encoding order for blocks. The intra-prediction module 46 may be configured with a variety of different intra-prediction modes. For example, the intra-prediction module 46 may be configured with a certain number of directional prediction modes, e.g., thirty-five directional prediction modes, based on the size of the CU being encoded.

The intra-prediction module 46 may select an intra-prediction mode by, for example, calculating error values for various intra-prediction modes and selecting a mode that yields the lowest error value. Directional prediction modes may include functions for combining values of spatially neighboring pixels and applying the combined values to one or more pixel positions in a PU. Once values for all pixel positions in the PU have been calculated, the intra-prediction module 46 may calculate an error value for the prediction mode based on pixel differences between the PU and the received block to be encoded. The intra-prediction module 46 may continue testing intra-prediction modes until an intra-prediction mode that yields an acceptable error value is discovered. The intra-prediction module 46 may then send the PU to the summer 50.

The video encoder 20 forms a residual block by subtracting the prediction data calculated by the motion compensation unit 44 or the intra-prediction module 46 from the original video block being coded. The summer 50 represents the component or components that perform this subtraction operation. The residual block may correspond to a two-dimensional matrix of pixel difference values, where the number of values in the residual block is the same as the number of pixels in the PU corresponding to the residual block. The values in the residual block may correspond to the differences, i.e., error, between values of co-located pixels in the PU and in the original block to be coded. The differences may be chroma or luma differences depending on the type of block that is coded.

The transform module 52 may form one or more transform units (TUs) from the residual block. The transform module 52 selects a transform from among a plurality of transforms. The transform may be selected based on one or more coding characteristics, such as block size, coding mode, or the like. The transform module 52 then applies the selected transform to the TU, producing a video block comprising a two-dimensional array of transform coefficients. The transform module 52 may signal the selected transform partition in the encoded video bitstream.

The transform module 52 may send the resulting transform coefficients to the quantization unit 54. The quantization unit 54 may then quantize the transform coefficients. The entropy encoding unit 56 may then perform a scan of the quantized transform coefficients in the matrix according to a scanning mode. This disclosure describes the entropy encoding unit 56 as performing the scan. However, it should be understood that, in other examples, other processing units, such as the quantization unit 54, could perform the scan.

Once the transform coefficients are scanned into the one-dimensional array, the entropy encoding unit 56 may apply entropy coding such as CAVLC, CABAC, syntax-based context-adaptive binary arithmetic coding (SBAC), or another entropy coding methodology to the coefficients.

To perform CAVLC, the entropy encoding unit 56 may select a variable length code for a symbol to be transmitted. Codewords in VLC may be constructed such that relatively shorter codes correspond to more likely symbols, while longer codes correspond to less likely symbols. In this way, the use of VLC may achieve a bit savings over, for example, using equal-length codewords for each symbol to be transmitted.

To perform CABAC, the entropy encoding unit 56 may select a context model to apply to a certain context to encode symbols to be transmitted. The context may relate to, for example, whether neighboring values are non-zero or not. The entropy encoding unit 56 may also entropy encode syntax elements, such as the signal representative of the selected transform. In accordance with the techniques of this disclosure, the entropy encoding unit 56 may select the context model used to encode these syntax elements based on, for example, an intra-prediction direction for intra-prediction modes, a scan position of the coefficient corresponding to the syntax elements, block type, and/or transform type, among other factors used for context model selection.

Following the entropy coding by the entropy encoding unit 56, the resulting encoded video may be transmitted to another device, such as the video decoder 30, or archived for later transmission or retrieval.

In some cases, the entropy encoding unit 56 or another unit of the video encoder 20 may be configured to perform other coding functions, in addition to entropy coding. For example, the entropy encoding unit 56 may be configured to determine coded block pattern (CBP) values for CU's and PU's. Also, in some cases, the entropy encoding unit 56 may perform run length coding of coefficients.

The inverse quantization unit 58 and the inverse transform module 60 apply inverse quantization and inverse transformation, respectively, to reconstruct the residual block in the pixel domain, e.g., for later use as a reference block. The motion compensation unit 44 may calculate a reference block by adding the residual block to a predictive block of one of the frames of the reference frame buffer 64. The motion compensation unit 44 may also apply one or more interpolation filters to the reconstructed residual block to calculate sub-integer pixel values for use in motion estimation. The summer 62 adds the reconstructed residual block to the motion compensated prediction block produced by the motion compensation unit 44 to produce a reconstructed video block.

The summer 62 combines the residual blocks with the corresponding prediction blocks generated by the motion compensation unit 44 or the intra-prediction module 46 to form decoded blocks. The loop filters (deblocking filter 53, SAO unit 55, and ALF unit 57) then perform loop filtering in accordance with the techniques described above. In particular, loop filtering operations may be allowed across tile boundaries for some tiles and may be disallowed from being performed across tile boundaries for some tiles. Syntax elements indicating if loop filtering operations are allowed across tile boundaries may be included in the encoded video bitstream.

After loop filtering, the filtered reconstructed video block is then stored in the reference frame buffer 64. The reconstructed video block may be used by the motion estimation unit 42 and the motion compensation unit 44 as a reference block to inter-code a block in a subsequent video frame.

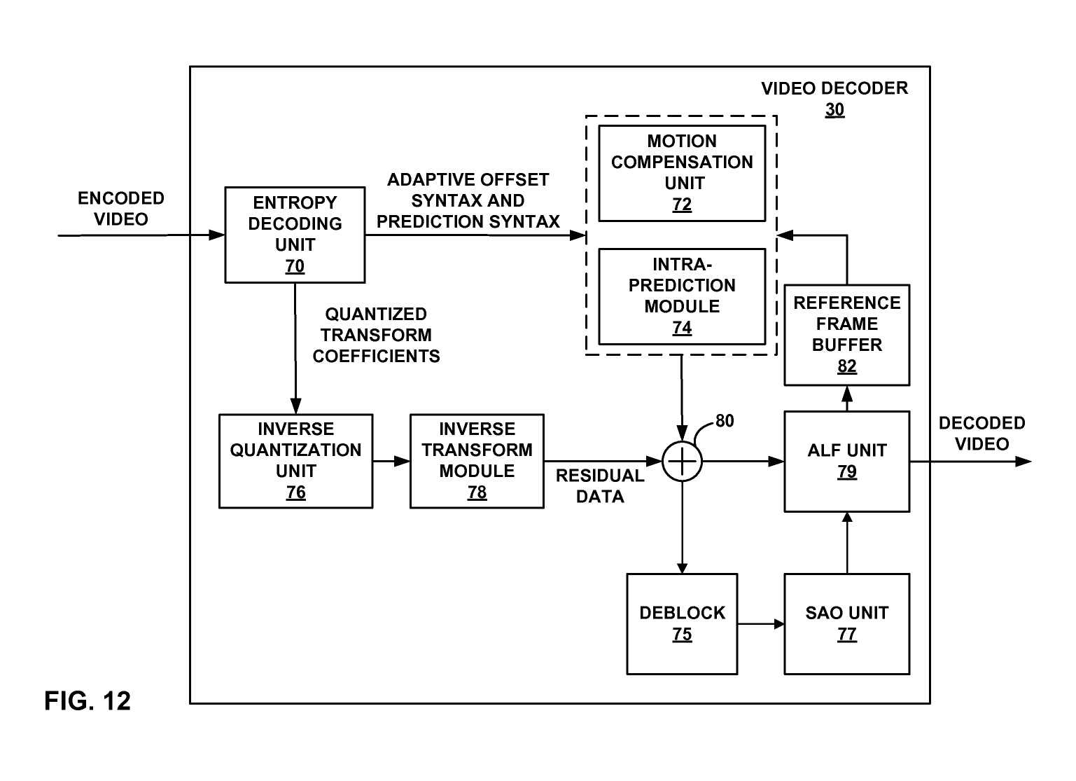

FIG. 12 is a block diagram illustrating an example of a video decoder 30, which decodes an encoded video sequence. In the example of FIG. 12, the video decoder 30 includes an entropy decoding unit 70, a motion compensation unit 72, an intra-prediction module 74, an inverse quantization unit 76, an inverse transformation unit 78, a reference frame buffer 82, a deblocking filter 75, a SAO unit 77, and an ALF unit 79, and a summer 80. The video decoder 30 may, in some examples, perform a decoding pass generally reciprocal to the encoding pass described with respect to the video encoder 20 (see FIG. 11).

The entropy decoding unit 70 performs an entropy decoding process on the encoded bitstream to retrieve a one-dimensional array of transform coefficients. The entropy decoding process used depends on the entropy coding used by the video encoder 20 (e.g., CABAC, CAVLC, etc.). The entropy coding process used by the encoder may be signaled in the encoded bitstream or may be a predetermined process.

In some examples, the entropy decoding unit 70 (or the inverse quantization unit 76) may scan the received values using a scan mirroring the scanning mode used by the entropy encoding unit 56 (or the quantization unit 54) of the video encoder 20. Although the scanning of coefficients may be performed in the inverse quantization unit 76, scanning will be described for purposes of illustration as being performed by the entropy decoding unit 70. In addition, although shown as separate functional units for ease of illustration, the structure and functionality of the entropy decoding unit 70, the inverse quantization unit 76, and other units of the video decoder 30 may be highly integrated with one another.

The inverse quantization unit 76 inverse quantizes, i.e., de-quantizes, the quantized transform coefficients provided in the bitstream and decoded by the entropy decoding unit 70. The inverse quantization process may include a conventional process, e.g., similar to the processes proposed for HEVC or defined by the H.264 decoding standard. The inverse quantization process may include use of a quantization parameter QP calculated by the video encoder 20 for the CU to determine a degree of quantization and, likewise, a degree of inverse quantization that should be applied. The inverse quantization unit 76 may inverse quantize the transform coefficients either before or after the coefficients are converted from a one-dimensional array to a two-dimensional array.

The inverse transform module 78 applies an inverse transform to the inverse quantized transform coefficients. In some examples, the inverse transform module 78 may determine an inverse transform based on signaling from the video encoder 20, or by inferring the transform from one or more coding characteristics such as block size, coding mode, or the like. In some examples, the inverse transform module 78 may determine a transform to apply to the current block based on a signaled transform at the root node of a quadtree for an LCU including the current block. Alternatively, the transform may be signaled at the root of a TU quadtree for a leaf-node CU in the LCU quadtree. In some examples, the inverse transform module 78 may apply a cascaded inverse transform, in which inverse transform module 78 applies two or more inverse transforms to the transform coefficients of the current block being decoded.

The intra-prediction module 74 may generate prediction data for a current block of a current frame based on a signaled intra-prediction mode and data from previously decoded blocks of the current frame.

Based on the retrieved motion prediction direction, reference frame index, and calculated current motion vector, the motion compensation unit produces a motion compensated block for the current portion. These motion compensated blocks essentially recreate the predictive block used to produce the residual data.

The motion compensation unit 72 may produce the motion compensated blocks, possibly performing interpolation based on interpolation filters. Identifiers for interpolation filters to be used for motion estimation with sub-pixel precision may be included in the syntax elements. The motion compensation unit 72 may use interpolation filters as used by the video encoder 20 during encoding of the video block to calculate interpolated values for sub-integer pixels of a reference block. The motion compensation unit 72 may determine the interpolation filters used by the video encoder 20 according to received syntax information and use the interpolation filters to produce predictive blocks.

Additionally, the motion compensation unit 72 and the intra-prediction module 74, in an HEVC example, may use some of the syntax information (e.g., provided by a quadtree) to determine sizes of LCUs used to encode frame(s) of the encoded video sequence. The motion compensation unit 72 and the intra-prediction module 74 may also use syntax information to determine split information that describes how each CU of a frame of the encoded video sequence is split (and likewise, how sub-CUs are split). The syntax information may also include modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence.

The summer 80 combines the residual blocks with the corresponding prediction blocks generated by the motion compensation unit 72 or the intra-prediction module 74 to form decoded blocks. The loop filters (deblocking filter 75, SAO unit 77, and ALF unit 79) then perform loop filtering in accordance with the techniques described above. In particular, syntax elements in the encoded video bitstream may allow loop filtering operations to be performed across tile boundaries for some tiles and may disallow loop filtering operations from being performed across tile boundaries for some tiles.

Example syntax and semantics for controlling in-loop filtering across tile boundaries according to the techniques of this disclosure will now be described. Video encoder 20 may, for example, be configured to generate a bitstream of coded video data that includes the syntax elements described, and video decoder 30 may be configured to parse such syntax elements. Table 1 below shows an example of how the syntax elements described in this disclosure may be implemented into a sequence parameter set. Table 2 below shows an example of how the syntax elements described in this disclosure may be implemented into a picture parameter set.

TABLE 1

| seq_parameter_set_rbsp( ) { | Descriptor |
|---|---|
| profile_idc | u(8) |
| reserved_zero_8bits /* equal to 0 */ | u(8) |
| level_idc | u(8) |
| seq_parameter_set_id | ue(v) |
| pic_width_in_luma_samples | u(16) |
| pic_height_in_luma_samples | u(16) |
| bit_depth_luma_minus8 | ue(v) |
| bit_depth_chroma_minus8 | ue(v) |
| bit_depth_luma_increment | ue(v) |
| bit_depth_chroma_increment | ue(v) |
| log2_max_frame_num_minus4 | ue(v) |
| pic_order_cnt_type | ue(v) |
| if( pic_order_cnt_type = = 0 ) | |
| log2_max_pic_order_cnt_lsb_minus4 | ue(v) |
| else if( pic_order_cnt_type = = 1) { | |
| delta_pic_order_always_zero_flag | u(1) |
| offset_for_non_ref_pic | se(v) |
| num_ref_frames_in_pic_order_cnt_cycle | ue(v) |
| for( i = 0; i<num_ref_frames_in_ | |
| pic_order_cnt_cycle; i++ ) | |
| offset_for_ref_frame[ i ] | se(v) |
| } | |
| max_num_ref_frames | ue(v) |
| gaps_in_frame_num_value_allowed_flag | u(1) |
| log2_min_coding_block_size_minus3 | ue(v) |
| log2_diff_max_min_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| interpolation_filter_flag | u(1) |
| num_tile_columns_minus1 | ue(v) |
| num_tile_rows_minus1 | ue(v) |
| if (num_tile_columns_minus1 != 0 ∥ | |
| num_tile_rows_minus1 != 0) { | |
| tile_boundary_independence_idc | u(1) |
| tile_boundary_loop_filtering_idc | ue(v) |
| uniform_spacing_idc | u(1) |
| if (uniform_spacing_idc != 1) { | |
| for (i=0; i<num_tile_columns_minus1 ; i++) | |
| column_width[i] | ue(v) |
| for (i=0; i<num_tile_rows_minusl; i++) | |
| row_height[i] | ue(v) |
| } | |
| if( tile_boundary_loop_filtering_idc = = 2 && | |
| num_tile_columns_minus1 ) | |
| for( i = 0; i < num_tile_columns_minus1; i++ ) | |
| vertical_tile_boundary_loop_filering_flag[ i ] | u(1) |
| if( tile_boundary_loop_filtering_idc = = 2 && | |
| num_tile_rows_minus1 ) | |
| for( i = 0; i < num_tile_rows_minus1; i++) | |
| horizontal_tile_boundary_loop_filtering_flag[ i ] | u(1) |
| } | |
| rbsp_trailing_bits( ) | |
| } | |

TABLE 2

| pic_parameter_set_rbsp( ) { | Descriptor |
|---|---|
| pic_parameter_set_id | ue(v) |
| seq_parameter_set_id | ue(v) |
| entropy_coding_mode_flag | u(1) |
| num_ref_idx_10_default_active_minus1 | ue(v) |
| num_ref_idx_11_default_active_minus1 | ue(v) |
| pic_init_qp_minus26/* relative to 26 */ | se(v) |
| constrained_intra_pred_flag | u(1) |
| tile_info_present_flag | u(1) |
| if (tile_info_present_flag == 1) { | |
| num_tile_columns_minus1 | ue(v) |
| num_tile_rows_minus1 | ue(v) |
| if (num_tile_columns_minus1 !=0 ∥ | |
| num_tile_rows_minus1 !=0) { | |
| tile_boundary_independence_idc | u(1) |
| tile_boundary_loop_filtering_idc | ue(v) |
| uniform_spacing_idc | u(1) |
| if (uniform_spacing_idc !=1) { | |
| for (i=0; i<num_tile_columns_minus1 ; i++) | |
| column_width [i] | ue(v) |
| for (i=0; i <num_tile_rows_minus1; i++) | |
| row_height [i] | ue(v) |
| } | |
| if( tile_boundary_loop_filtering_idc = = 2 && | |
| num_tile_columns_minus1 ) | |
| for( i = 0; i < num_tile_columns_minus1; i++ ) | |
| vertical_tile_boundary_loop_filering_flag[ i ] | u(1) |
| if( tile_boundary_loop_filtering_idc = = 2 && | |
| num_tile_rows_minus1 ) | |
| for( i = 0; i < num_tile_rows_minus 1; i++ ) | |
| horizontal_tile_boundary_loop_filtering_flag[ i ] | u(1) |
| } | |
| } | |
| rbsp_trailing_bits( ) | |
| } | |

In the examples above, the syntax element “tile_boundary_loop_filtering_idc” equal to 0 may specify that loop filtering operations, including deblocking loop filtering, ALF, and SAO, are disallowed across all tile boundaries. The syntax element “tile_boundary_loop_filtering_idc” equal to 1 may specify that loop filtering operations are allowed across all tile boundaries. The syntax element “tile_boundary_loop_filtering_idc” equal to 2 may indicate that the allowance of loop filtering operations is specified by the syntax elements “vertical_tile_boundary_loop_filtering_flag[i]” and “horizontal_tile_boundary_loop_filtering_flag[i].” These values are merely one example and may be changed in other examples.

The syntax element “vertical_tile_boundary_loop_filtering_flag[i]” equal to 0 may specify that loop filtering operations are allowed across the vertical tile boundary with index value equal to i plus 1. The vertical tile boundary index is 0 for the left vertical picture boundary and counted from left to right, increased by 1 for each vertical tile boundary. The syntax element “vertical_tile_boundary_loop_filtering_flag[i]” equal to 1 may specify that loop filtering operations, including deblocking loop filtering, ALF, and SAO, are disallowed across the vertical tile boundary with index value equal to i plus 1.

The syntax element “horizontal_tile_boundary_loop_filtering_flag[i]” equal to 0 may specify that loop filtering operations are allowed across the horizontal tile boundary with index value equal to i plus 1. In one example, the horizontal tile boundary index may be 0 for the upper horizontal picture boundary and counted from top to bottom, increased by 1 for each horizontal tile boundary. The syntax element “horizontal_tile_boundary_loop_filtering_flag[i]” equal to 1 may specify that loop filtering operations are disallowed across the horizontal tile boundary with index value equal to i plus 1.

In an example decoding process, when the syntax elements “horizontal_tile_boundary_loop_filtering_flag” and “vertical_tile_boundary_loop_filtering_flag” are equal to 1, normal filtering operations may be performed. If the syntax elements “horizontal_tile_boundary_loop_filtering_flag” or “vertical_tile_boundary_loop_filtering_flag” are equal to 0, the in loop filtering operations may be disabled across the horizontal or vertical boundary. For ALF operations near the boundary, access to the pixels across the boundary may be needed, which is sometimes substituted with padded pixels, which may cause visual quality degradation across the boundary pixels when filtered. Therefore, the alternative ways of ALF filtering operation across the boundary as described in above can be used.

In another example, the syntax element “tile_boundary_loop_filtering_idc” may be coded with 1 bit, and when equal to 0 has the same semantics as the syntax element “tile_boundary_loop_filtering_idc” equal to 0 as in the previous example, and when equal to 1 has the same semantics as the syntax element “tile_boundary_loop_filtering_idc” equal to 0, and syntax elements “vertical_tile_boundary_loop_filtering_flag[i]” and “horizontal_tile_boundary_loop_filtering_flag[i]” are not present. In other words, loop filtering operations may be either allowed for both horizontal and vertical tile boundaries or may be disallowed for both horizontal and vertical tile boundaries.

In one example, the tile boundaries across which loop filtering operations are disallowed may be explicitly signaled, and loop filtering operations across other tile boundaries may be allowed. Alternatively, the tile boundaries across which loop filtering operations are allowed may be explicitly signaled, and loop filtering operations across other tile boundaries may be disallowed. In one example, a flag may be included in the bitstream for each tile boundary between two neighboring tiles to specify whether loop filtering operations across the tile boundary is allowed.

In all the above examples, the tile boundary may be identified by a pair of tile indexes, where each tile index identifies a tile in a picture. A tile index may be the index of the tile to the tile raster scan order of all tiles in the picture, starting from 0.

In one example, a flag may be included in the bitstream for each slice to specify whether loop filtering operations across all tile boundaries inside the region covered by all LCUs in the slice are allowed.

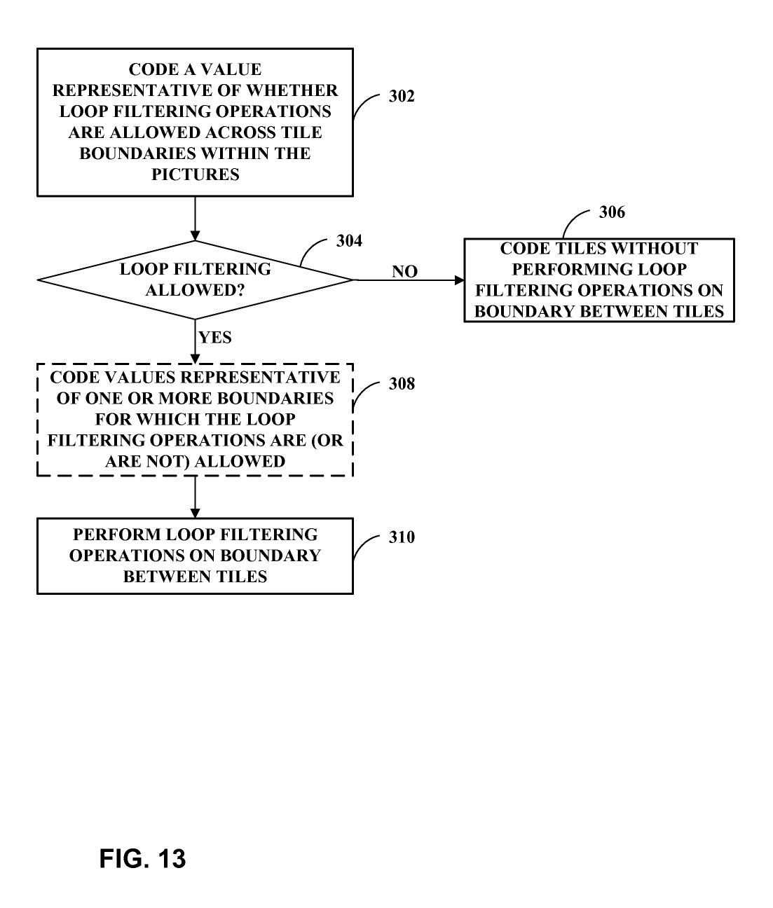

FIG. 13 shows a flowchart depicting an example method of controlling loop filtering across tile boundaries according to this disclosure. The techniques shown in FIG. 13 may be implemented by either video encoder 20 or video decoder 30 (generally by a video coder). A video coder may be configured to code, for one or more pictures of video data that are partitioned into tiles, a value representative of whether loop filtering operations are allowed across tile boundaries within the pictures (302). In response to the value indicating that the loop filtering operations are not allowed across tile boundaries (304, no), the video coder may code the tiles without performing loop filtering operations on a boundary between tiles of at least one of the pictures (306). Loop filter may be disallowed, for example, in instances where it is desirable to code two or more tiles in parallel. In response to the value indicating that the loop filtering operations are allowed (304, yes), then the video coder may optionally code values representative of one or more boundaries for which the loop filtering operations are (or are not) allowed (308). The video coder may, for example, code a series of flags, with each flag corresponding to a particular boundary, and the value of flag indicating if cross-tile-boundary loop filtering is allowed or disallowed for each boundary. The video coder may also code explicit indications of for which boundaries cross-tile-boundary loop filtering operations are allowed (or not allowed). The explicit indication may, for example, include an index of one or more tiles on the boundary.

The video coder may perform the loop filtering operations on at least one boundary between tiles of at least one of the pictures (310). The loop filtering operations may include one or more of deblocking filtering, adaptive loop filtering, and sample adaptive offset filtering, as described above.

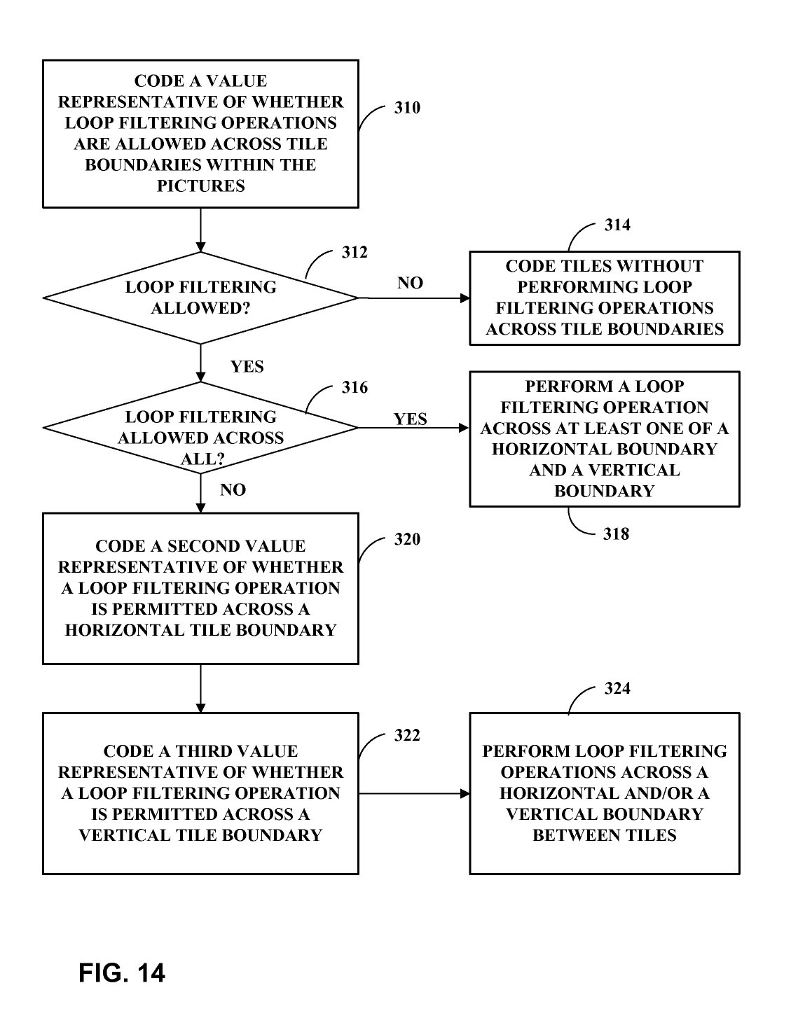

FIG. 14 shows a flowchart depicting an example method of controlling loop filtering across tile boundaries according to this disclosure. The techniques shown in FIG. 14 may be implemented by either video encoder 20 or video decoder 30 (generally by a video coder). A video coder may be configured to code, for one or more pictures of video data that are partitioned into tiles, a value representative of whether loop filtering operations are allowed across tile boundaries within the pictures (310). The value may, for example, be one of three possible values, where a first value indicates loop filtering is not allowed across all tile boundaries, a second value indicates loop filtering is allowed across all tile boundaries, and a third value indicates that separate syntax elements for horizontal boundaries and vertical boundaries will be coded separately. In response to the value indicating that the loop filtering operations are not allowed across tile boundaries (312, no), then the video coder may code the tiles without performing the loop filtering operations across boundaries between tiles of at least one of the pictures (314). In response to the value indicating that the loop filtering operations are allowed across all tile boundaries (316, yes), then the video coder may perform the loop filtering operations across at least one of a horizontal tile boundary and a vertical tile boundary (318).

In response to the value indicating that the loop filtering operations are neither disallowed across all tile boundaries nor allowed across all tile boundaries (316, no), then the video coder may code a second value indicating if loop filtering operations are allowed across a tile boundary in the horizontal direction (320). The video coder may also code a third value indicating if loop filtering operations are allowed across a tile boundary in a vertical direction (322). Based on the second and third values, the video coder may perform filtering operations across a horizontal boundary between tiles, a vertical boundary between tiles, or both (324).

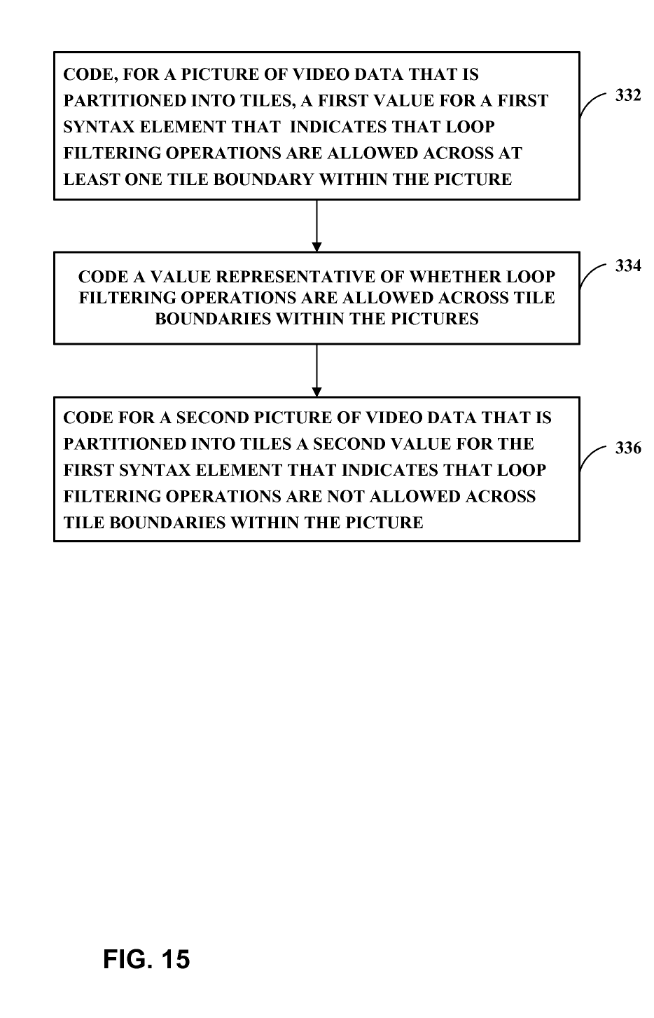

FIG. 15 shows a flowchart depicting an example method of controlling loop filtering across tile boundaries according to this disclosure. The techniques shown in FIG. 15 may be implemented by either video encoder 20 or video decoder 30 (generally by a video coder). A video coder may be configured to code, for a picture of video data that is partitioned into tiles, a first value for a first syntax element, where the first value for the first syntax element indicates that loop filtering operations are allowed across at least one tile boundary within the picture (332). The video coder may perform the one or more loop filtering operations across the at least one tile boundary in response to the first value indicating that the loop filtering operations are allowed across the tile boundary (334). The one or more loop filtering operations may include, for example, one or more of a deblocking filtering operation, an adaptive loop filtering operation, and a sample adaptive offset filtering operation. The video coder may, for a second picture of video data that is partitioned into tiles, code a second value for the first syntax element, where the second value for the first syntax element can indicate that loop filtering operations are not allowed across tile boundaries within the picture (336).

In some video coders, the first value for the first syntax element may indicate that loop filtering operations are allowed across all tile boundaries within the picture, while in other video coders the first value for the first syntax element may indicate that additional syntax element will be used to identify boundaries for which cross-tile-boundary loop filtering operations are allowed (or disallowed). In video coders where the first value indicates that additional syntax element will be used to identify boundaries for which cross-tile-boundary loop filtering operations are allowed (or disallowed), the video coder may code a value representative of a horizontal boundary for which the loop filtering operations are allowed and/or code a value representative of a horizontal boundary for which the loop filtering operations are not allowed. The video coder may code a value representative of a vertical boundary for which the loop filtering operations are allowed and/or code a value representative of a vertical boundary for which the loop filtering operations are not allowed.

In video coders where the first value indicates that additional syntax element will be used to identify boundaries for which cross-tile-boundary loop filtering operations are allowed (or disallowed), the video coders may code a syntax element representative of whether loop filtering operations are allowed across a tile boundary within the pictures in a horizontal direction and/or may code a syntax element representative of whether loop filtering operations are allowed across a tile boundary within the pictures in a vertical direction.

In video coders where the first value indicates that additional syntax element will be used to identify boundaries for which cross-tile-boundary loop filtering operations are allowed (or disallowed), the video coders may code a third value for the first syntax element to indicate that loop filtering operations are allowed across all tile boundaries within the picture.

The video coder discussed with reference to FIGS. 13-15 may be either a video decoder or a video encoder. When the video coder is a video decoder, coding a value for a syntax element may, for example, refer to receiving the syntax element and determining a value for the syntax element. When the video coder is a video encoder, coding a syntax element may coding a syntax element may, for example, refer to generating the syntax element with the value so that the syntax element can be included in a bitstream of coded video data.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
coding, for a picture of video data that is partitioned into tiles, a first value for a first syntax element, wherein the first value for the first syntax element indicates that loop filtering operations are allowed across at least one tile boundary within the picture; and,
performing the one or more loop filtering operations across the at least one tile boundary in response to the first value indicating that the loop filtering operations are allowed across the tile boundary.

2. The method of claim 1, wherein the one or more loop filtering operations comprise one or more of a deblocking filtering operation and a sample adaptive offset filtering operation.

3. The method of claim 1, wherein the one or more loop filtering operations comprise an adaptive loop filtering operation.

4. The method of claim 1, wherein the first value for the first syntax element indicates that loop filtering operations are allowed across all tile boundaries within the picture.

5. The method of claim 1, further comprising:
coding for a second picture of video data that is partitioned into tiles a second value for the first syntax element, wherein the second value for the first syntax element indicates that loop filtering operations are not allowed across tile boundaries within the second picture.

6. The method of claim 5, further comprising:
coding two or more tiles of the second picture in parallel.

7. The method of claim 1, further comprising:
coding for a third picture of video data that is partitioned into tiles a third value for the first syntax element, wherein the third value for the first syntax element indicates that loop filtering operations are allowed across all tile boundaries within the third picture.

8. The method of claim 1, further comprising:
in response to the first value for the first syntax element, coding a value representative of a horizontal boundary for which the loop filtering operations are allowed.

9. The method of claim 1, further comprising:
in response to the first value for the first syntax element, coding a value representative of a horizontal boundary for which the loop filtering operations are not allowed.

10. The method of claim 1, further comprising:
in response to the first value for the first syntax element, coding a value representative of a vertical boundary for which the loop filtering operations are allowed.

11. The method of claim 1, further comprising:
in response to the first value for the first syntax element, coding a value representative of a vertical boundary for which the loop filtering operations are not allowed.

12. The method of claim 1, further comprising:
in response to the first value for the first syntax element, coding a second syntax element representative of whether loop filtering operations are allowed across a tile boundary within the pictures in a horizontal direction.

13. The method of claim 1, further comprising:
in response to the first value for the first syntax element, coding a second syntax element representative of whether loop filtering operations are allowed across a tile boundary within the pictures in a vertical direction.

14. The method of claim 1, further comprising
in response to the first value for the first syntax element, coding a second syntax element representative of whether loop filtering operations are allowed across a horizontal tile boundary within the picture and coding a third syntax element representative of whether loop filtering operations are allowed across a vertical tile boundary within the picture.

15. The method of claim 1, wherein the first value corresponds to a slice of one of the pictures and represents whether the loop filtering operations are allowed across tile boundaries touched by the slice.

16. The method of claim 1, wherein the method is performed by a video decoder and wherein coding the first value for the first syntax element comprises receiving the first syntax element and determining the first value.

17. The method of claim 1, wherein the method is performed by a video encoder and wherein coding the first value of the first syntax element comprises generating the first syntax element with the first value for inclusion in a bitstream of coded video data.

18. A device for coding video data, the device comprising:
a video coder configured to code, for a picture of video data that is partitioned into tiles, a first value for a first syntax element, wherein the first value for the first syntax element indicates that loop filtering operations are allowed across at least one tile boundary within the picture; and, perform the one or more loop filtering operations across the at least one tile boundary in response to the first value indicating that the loop filtering operations are allowed across the tile boundary.

19. The device of claim 18, wherein the one or more loop filtering operations comprise one or more of a deblocking filtering operation and a sample adaptive offset filtering operation.

20. The device of claim 18, wherein the first value for the first syntax element indicates that loop filtering operations are allowed across all tile boundaries within the picture.

21. The device of claim 18, wherein the video coder is further configured to code for a second picture of video data that is partitioned into tiles a second value for the first syntax element, wherein the second value for the first syntax element indicates that loop filtering operations are not allowed across tile boundaries within the second picture.

22. The device of claim 21, wherein the video coder is further configured to code two or more tiles of the second picture in parallel.

23. The device of claim 18, wherein the video coder is further configured to code for a third picture of video data that is partitioned into tiles a third value for the first syntax element, wherein the third value for the first syntax element indicates that loop filtering operations are allowed across all tile boundaries within the third picture.

24. The device of claim 18, wherein the vide coder is further configured to code a value representative of a horizontal boundary for which the loop filtering operations are allowed in response to the first value for the first syntax element.

25. The device of claim 18, wherein the video coder is further configured to code a value representative of a horizontal boundary for which the loop filtering operations are not allowed in response to the first value for the first syntax element.

26. The device of claim 18, wherein the video coder is further configured to code a value representative of a vertical boundary for which the loop filtering operations are allowed in response to the first value for the first syntax element.

27. The device of claim 18, wherein the video coder is further configured to code a value representative of a vertical boundary for which the loop filtering operations are not allowed in response to the first value for the first syntax element.

28. The device of claim 18, wherein the video coder is further configured to code a second syntax element representative of whether loop filtering operations are allowed across a tile boundary within the pictures in a horizontal direction in response to the first value for the first syntax element.

29. The device of claim 18, wherein the video coder is further configured to code a second syntax element representative of whether loop filtering operations are allowed across a tile boundary within the pictures in a vertical direction in response to the first value for the first syntax element.

30. The device of claim 18, wherein the video coder is further configured to, in response to the first value for the first syntax element, code a second syntax element representative of whether loop filtering operations are allowed across a horizontal tile boundary within the picture and coding a third syntax element representative of whether loop filtering operations are allowed across a vertical tile boundary within the picture.

31. The device of claim 18, wherein the first value corresponds to a slice of one of the pictures and represents whether the loop filtering operations are allowed across tile boundaries touched by the slice.

32. The device of claim 18, wherein the video coder comprises a video decoder and wherein the video coder is further configured to code the first value for the first syntax element by receiving the first syntax element and determining the first value.

33. The device of claim 18, wherein the video coder comprises a video encoder and wherein the vide coder is further configured to code the first value of the first syntax element by generating the first syntax element with the first value for inclusion in a bitstream of coded video data.

34. The device of claim 18, wherein the device comprises at least one of:
an integrated circuit;
a microprocessor; and,
a wireless communications device that includes the video coder.

35. A device for coding video data, the device comprising:
means for coding, for a picture of video data that is partitioned into tiles, a first value for a first syntax element, wherein the first value for the first syntax element indicates that loop filtering operations are allowed across at least one tile boundary within the picture; and,
means for performing the one or more loop filtering operations across the at least one tile boundary in response to the first value indicating that the loop filtering operations are allowed across the tile boundary.

36. The device of claim 35, wherein the one or more loop filtering operations comprise one or more of a deblocking filtering operation, an adaptive loop filtering operation, and a sample adaptive offset filtering operation.

37. The device of claim 35, wherein the first value for the first syntax element indicates that loop filtering operations are allowed across all tile boundaries within the picture.

38. The device of claim 35, further comprising:
means for coding for a second picture of video data that is partitioned into tiles a second value for the first syntax element, wherein the second value for the first syntax element indicates that loop filtering operations are not allowed across tile boundaries within the second picture.

39. The device of claim 38, further comprising:
means for coding two or more slices of the second picture in parallel.

40. The device of claim 35, further comprising:
means for coding for a third picture of video data that is partitioned into tiles a third value for the first syntax element, wherein the third value for the first syntax element indicates that loop filtering operations are allowed across all tile boundaries within the third picture.

41. The device of claim 35, further comprising:
means for coding a value representative of a horizontal boundary for which the loop filtering operations are allowed in response to the first value for the first syntax element.

42. The device of claim 35, further comprising:
means for coding a value representative of a horizontal boundary for which the loop filtering operations are not allowed in response to the first value for the first syntax element.

43. The device of claim 35, further comprising:
means for coding a value representative of a vertical boundary for which the loop filtering operations are allowed in response to the first value for the first syntax element.

44. The device of claim 35, further comprising:
means for coding a value representative of a vertical boundary for which the loop filtering operations are not allowed in response to the first value for the first syntax element.

45. The device of claim 35, further comprising:
means for coding a second syntax element representative of whether loop filtering operations are allowed across a tile boundary within the pictures in a horizontal direction in response to the first value for the first syntax element.

46. The device of claim 35, further comprising:
means for coding a second syntax element representative of whether loop filtering operations are allowed across a tile boundary within the pictures in a vertical direction in response to the first value for the first syntax element.

47. The device of claim 35, further comprising
means for coding a second syntax element representative of whether loop filtering operations are allowed across a horizontal tile boundary within the picture in response to the first value for the first syntax element; and,
means for coding a third syntax element representative of whether loop filtering operations are allowed across a vertical tile boundary within the picture in response to the first value for the first syntax element.

48. The device of claim 35, wherein the first value corresponds to a slice of one of the pictures and represents whether the loop filtering operations are allowed across tile boundaries touched by the slice.

49. The device of claim 35, wherein the device comprises a video decoder and wherein the means for coding the first value for the first syntax element comprises means for receiving the first syntax element and means for determining the first value.

50. The device of claim 35, wherein the device comprises a video encoder and wherein the means for coding the first value of the first syntax element comprises means for generating the first syntax element with the first value for inclusion in a bitstream of coded video data.

51. A non-transitory computer-readable storage medium storing instructions that when executed by one or more processors cause the one or more processors to:
code, for a picture of video data that is partitioned into tiles, a first value for a first syntax element, wherein the first value for the first syntax element indicates that loop filtering operations are allowed across at least one tile boundary within the picture; and,
perform the one or more loop filtering operations across the at least one tile boundary in response to the first value indicating that the loop filtering operations are allowed across the tile boundary.
